(19) United States
(12) Patent Application Publication
(10) Pub. No.: US 2007/0043641 A1
(43) Pub. Date: Feb. 22, 2007

(54) Communication apparatus, communication system, communication method and recording medium

(75) Inventors: Ryuzo Tamayama, Kanagawa (JP); Akira Tange, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Sony Corporation

(21) Appl. No.: 11/589,061

(22) Filed: Oct. 30, 2006

Related U.S. Application Data
(62) Division of application No. 09/962,583, filed on Sep. 24, 2001.

(30) Foreign Application Priority Data
Sep. 25, 2000 (JP) 2000-291066

(51) Int. Cl. G06Q 40/00

(52) U.S. Cl. 705/35

(57) ABSTRACT

The present invention provides a communication system comprising a first communication apparatus and a second communication apparatus, wherein the first communication apparatus has rental-request-information-generating means for generating rental-request information, and transmitting means for transmitting the rental-request information generated by the rental-request-information-generating means, and the second communication apparatus has receiving means for receiving the rental-request information transmitted by the transmitting means, and recording means for recording a rental date of transmission of a rented storage medium for storing data in advance to a delivery destination and a return date of returning the rented storage medium from the delivery destination in accordance with the rental-request information received by the receiving means.

### BACKGROUND OF THE INVENTION

The present invention relates to a rental system and, in particular, the present invention is suitably applicable to a rental system for renting a storage medium.

In recent years, there has been started a music-distributing service for distributing pieces of music to personal computers, mobile telephones and portable terminals by way of the Internet. If there is a communication environment capable of downloading musical data, this music-distributing service offers much convenience of allowing the user to purchase musical data and do other activities without regard to places and time. Accordingly, the service draws much attention in these days.

On the other hand, the music-distributing service still has a number of problems which remain to be solved. An example of the unsolved problems is a need for a system that requires complex operations for preventing a musical source from being copied illegally, and adopts a copyright-protecting technology. That is to say, a music distributor always requires a system conforming to an SDMI (Secure Digital Music Initiative) which is an association for protecting copyrights of digital-music authors. By the same token, the user serving as a recipient of distributed pieces of music must also purchase a playback apparatus conforming to the SDMI.

In addition, there is also raised a problem of a low quality of distributed music in comparison with a CD (Compact Disk). This problem is caused by the fact that, prior to distribution of musical data to the users, the musical data is compressed by adoption of a compression technology such as an MP3 (a trademark; MPEG-1 audio layer 3) technique or an ATTRAC3 (a trademark; Adaptive Transform Acoustic Coding 3) technique in order to make the transmission time shorter.

It is not impossible to provide a technology for communicating CD-DA (CD-Digital Audio) in order to improve the quality of music. If factors such as the storage capacity of an HDD (Hard-Disk Driver) on the receiving side, the communication speed and the communication cost are totally taken into consideration, however, such a technology inevitably entails an in efficient system.

By the way, there is widely known a system renting storage media such as CDs. In such a system, the user visits a store of a rental company. The problems described above are not raised when the user is capable of borrowing a content with a desired title.

In such a rental system, however, the following problems arise between the user and the rental company.

There are many cases in which no such store is located at a place close to the home of the user. Thus, the user must take the trouble to visit such a store in order to borrow a content with a desired title, and in some cases only to find out that the user has to wait for several days for the content with the title to become available for rent. In addition, there are only few title selections available in a store visited by the user. Furthermore, the user must again visit the store in order to return a borrowed storage medium. As a result, the process to return a borrowed storage medium is troublesome as well as tiresome.

On the other hand, the rental company must prepare a stock that always keeps up with needs of customers, entailing an advance investment. To get a return of investment, the rental company should not keep unpopular titles or titles on a sales campaign produced by a small group of independent producers.

### SUMMARY OF THE INVENTION

It is thus an object of the present invention to provide a content rental system that allows the user to rent a content with a desired title selected from a rich stock at any time and to return the content without following a troublesome procedure.

It is another object of the present invention to provide a content rental system that does not require a rental company to prepare a stock.

To achieve the above objects, according to a first aspect of the present invention, there is provided a communication system including a first communication apparatus and a second communication apparatus. The first communication apparatus has rental-request-information-generating means for generating rental-request information, and transmitting means for transmitting the rental-request information generated by the rental-request-information-generating means. The second communication apparatus has receiving means for receiving the rental-request information transmitted by the transmitting means, and recording means for recording a rental date of transmission of a rented storage medium for storing data in advance to a delivery destination and a return date of returning the rented storage medium from the delivery destination in accordance with the rental-request information received by the receiving means.

According to a second aspect of the present invention, there is provided a communication system including a first communication apparatus and a second communication apparatus. The first communication apparatus has rental-request-information-generating means for generating rental-request information including a musical-data ID and a storage-medium ID of respectively musical data and a storage medium which are desired by the user, and transmitting means for transmitting the rental-request information generated by the rental-request-information-generating means. The second communication apparatus has receiving means for receiving the rental-request information transmitted by the transmitting means, search means for searching for musical data identified by the musical-data ID included in the rental-request information received by the receiving means, write means for writing the musical data searched for by the search means and the musical-data ID into a storage medium identified by the storage-medium ID, and recording means for recording a rental date of transmission of a rented storage medium to a delivery destination and a return date of returning the rented storage medium from the delivery destination.

According to a third aspect of the present invention, there is provided a communication apparatus including receiving means for receiving rental-request information transmitted by an external apparatus, search means for searching for content data identified by a content-data ID included in the rental-request information received by the receiving means, write means for writing the content data searched for by the search means and the content-data ID into a storage medium identified by a storage-medium ID included in the rental-request information, and recording means for recording a rental date of transmission of a rented storage medium to a delivery destination and a return date of returning the rented storage medium from the delivery destination.

According to a fourth aspect of the present invention, there is provided a communication apparatus including input means for inputting a content-data ID and a storage-medium ID of respectively content data and a storage medium, which are desired by the user, and for inputting an address of a delivery destination serving as a recipient of the storage medium, rental-request-information-generating means for generating rental-request information including the content-data ID, the storage-medium ID and the address, which are input by the input means, and transmitting means for transmitting the rental-request information generated by the rental-request-information-generating means.

According to the present invention, there is provided a rental system having a configuration in which the user operates a terminal to make an access to a rental server and, if the user places an order for a desired storage medium for rent during the access, the storage medium is delivered to the user. Thus, the user is capable of renting a desired storage medium without taking the trouble to visit a rental store. In addition, there is no longer a problem that a desired storage medium is not available at the rental store because the storage medium is being rented to another user as is the case with the conventional rental shop. As a result, the user is capable of renting storage mediums with desired titles at any time.

Furthermore, in accordance with the present invention, the rental company does not have to keep storage mediums containing contents in stock as is the case with the conventional rental shop. Thus, the rental company does not need to invest money for such a storage and is, hence, capable of keeping the rental cost low. Moreover, the rental company is capable of handling contents each having a title other than popular titles. That is to say, the rental company deals with not only contents performed by new artists, but also contents of various genres such as songs for education and songs for children. In addition, the rental company is also capable of aggressively promoting genres such as indie titles and Japanese popular ballads. Furthermore, since it is not necessary to keep storage mediums in stock, the number of investment-failure risks that the rental company may incur can be reduced.

Moreover, since the rental company always records a content onto a new storage medium, the customer also enjoys the new storage medium or a storage medium with no injury, dirt and the like unlike an ordinary rental shop. In addition, unlike an ordinary rental business, a fee paid for a rented content is automatically apportioned among all parties involved in the renting of the content under computer control. Thus, unlike the conventional rental system, the rental company does not have to carry out cumbersome settlement processing. Furthermore, since a rented storage medium overdue beyond a rental period is automatically purchased by the user, the rental company is capable of simplifying processing such as making a request to return the overdue storage medium.

In addition, since the fee-settlement company holds deposited money of a predetermined amount for a rental period, the fee-settlement company is capable of circulating the money for business purposes during the rental period. Furthermore, since the fee-settlement company carries out fee settlements when a storage medium is rented and returned, 2 fees can be collected for the fee settlements.

Moreover, in accordance with the present invention, fees of copyrights classified by title and by artist can be collected from a rental shop. Thus, unlike the conventional rental system, the author is capable of collecting detailed rental fees.

In addition, in accordance with the present invention, a content is recorded onto a storage medium desired by the user and rented to the user. Thus, by purchasing the rented storage medium, the user no longer needs to carry out troublesome work of copying a content as the user did in the conventional rental system. That is to say, since it is quite within the bounds of possibility that the user purchases a rented storage medium, the rental company may expect a revenue of selling rented storage mediums.

Furthermore, in accordance with the present invention, a post office is used as product-delivery and product-returning means. Thus, the post office may also expect more postal matters to handle.

To above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a block diagram showing the configuration of a rental system implemented by an embodiment of the present invention;

FIG. 2 is a diagram showing a typical home page according to the embodiment of the present invention in a simple and plain manner;

FIG. 3 is a diagram showing a typical home page according to the embodiment of the present invention in a simple and plain manner;

FIG. 4 is a diagram showing a typical home page according to the embodiment of the present invention in a simple and plain manner;

FIG. 5 is a diagram showing a typical home page according to the embodiment of the present invention in a simple and plain manner;

FIG. 6 is a block diagram showing the configuration of a user terminal implemented by an embodiment of the present invention;

FIG. 7 is a diagram showing the structure of rental request information in the embodiment of the present invention in a simple and plain manner;

FIG. 8 is a diagram showing the structure of requested-music-related information in the embodiment of the present invention in a simple and plain manner;

FIG. 9 is a diagram showing the structure of rental-condition information in the embodiment of the present invention in a simple and plain manner;

FIG. 10 is a diagram showing the structure of fee-settlement information in the embodiment of the present invention in a simple and plain manner;

FIG. 11 is a block diagram showing the configuration of a service provider implemented by an embodiment of the present invention;

FIG. 12 is a block diagram showing the configuration of a content provider implemented by an embodiment of the present invention;

FIG. 13 is a block diagram showing the configuration of a rental server implemented by an embodiment of the present invention;

FIG. 14 is a block diagram showing the configuration of a billing server implemented by an embodiment of the present invention;

FIG. 15 is a block diagram showing the configuration of a post office implemented by an embodiment of the present invention;

FIG. 16 is a flowchart used for explaining processing carried out by the user terminal implemented by the embodiment of the present invention;

FIG. 17 is a flowchart used for explaining processing carried out by the service provider implemented by the embodiment of the present invention;

FIG. 18 is a flowchart used for explaining processing carried out by the content provider implemented by the embodiment of the present invention;

FIG. 19 is a flowchart used for explaining processing carried out by the rental server implemented by the embodiment of the present invention;

FIG. 20 is a flowchart used for explaining processing carried out by the billing server implemented by the embodiment of the present invention;

FIG. 21 is a flowchart used for explaining processing carried out by the post office implemented by the embodiment of the present invention;

FIG. 22 is a diagram showing an external appearance of a special package, which is provided by an embodiment of the present invention for shipping a rented content, in a simple and plain manner;

FIG. 23 is a diagram showing the structure of the special package, which is provided by the embodiment of the present invention, in a simple and plain manner;

FIG. 24 is a diagram showing an external appearance of a special package, which is provided by the embodiment of the present invention to be used by the user for returning a rented content, in a simple and plain manner;

FIG. 25 is a diagram showing a typical home page according to the embodiment of the present invention in a simple and plain manner; and

FIG. 26 is a block diagram showing a typical implementation of the user terminal implemented by an embodiment of the present invention.

### PREFERRED EMBODIMENTS OF THE INVENTION

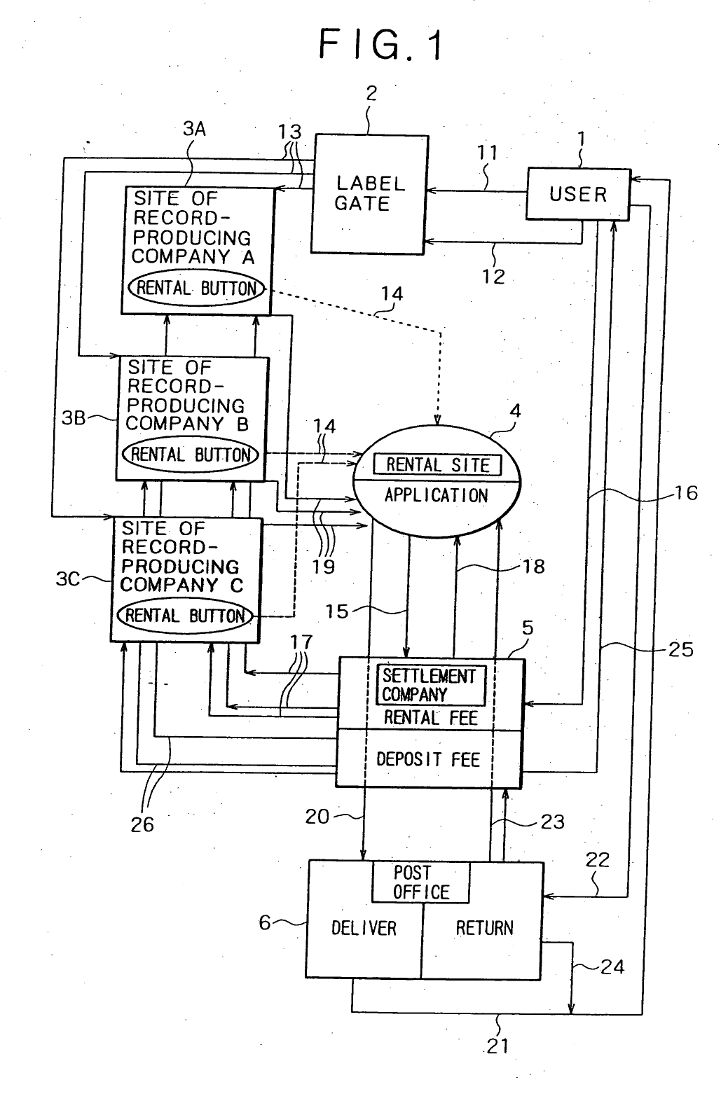

Preferred embodiments of the present invention are explained by referring to diagrams as follows. FIG. 1 is a diagram showing the configuration of an entire rental system implemented by a first embodiment of the present invention. As shown in the figure, the rental system comprises the user 1, a service provider (a label gate: a trademark) 2, content providers 3, a rental server (a rental company) 4, a billing server (a fee settlement company) 5 and a post office 6. A label gate is a portal site for a plurality of content providers. In this embodiment, the content providers 3 are an A content provider company 3A, a B content provider company 3B and a C content provider company 3C. A content provider is a record-producing company.

The following description explains a flow, from placing an order for a content to be rented, to returning the rented content, in a rental system implemented by the embodiment having the configuration described above.

First of all, the user 1 makes an access to the service provider 2 by using a user terminal such as a mobile telephone or a portable terminal 12 through the Internet, and displays a home page on the user terminal.

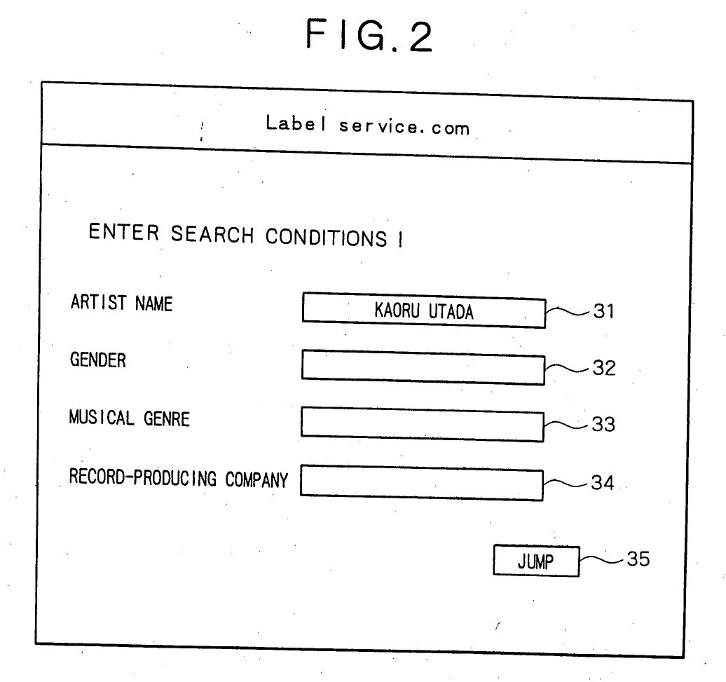

FIG. 2 is a diagram showing a typical home page displayed on the user terminal as a result of the access to the service provider 2. As shown in FIG. 2, the home page includes an artist-name input column 31, a gender input column 32, a musical-genre input column 33, a record-producing-company input column 34 used for entering search conditions and a jump button 35.

Next, the user 1 enters search conditions in the above-described input columns. Then, the user 1 presses the jump button 35 to jump (make a link 13) to the site of the content provider 3.

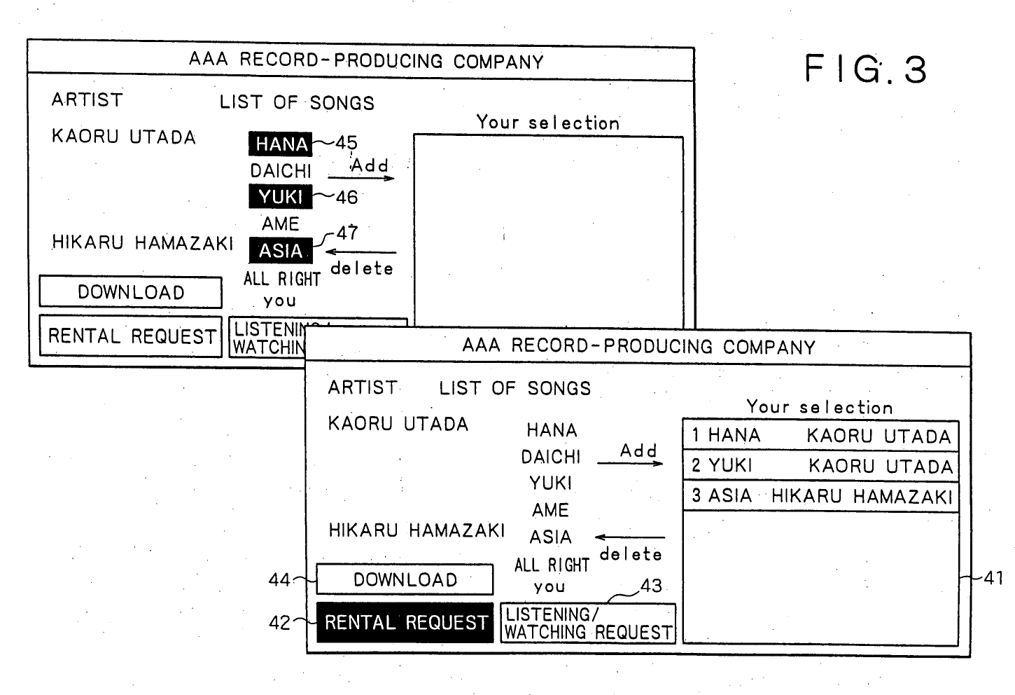

FIG. 3 is a diagram showing typical home pages displayed as a result of establishment of the link 13 to the site of the content provider 3. These home pages each include results of a search according to conditions of the search. As described above, the conditions of the search are the name of an artist and the name of a song. The home pages also each include a selection box 41, a rental request button 42, a watching/listening request button 43 and a download button 44.

The user 1 selects songs the user 1 wants to rent. In this example, the user 1 selects pieces of music which are denoted by reference numerals 45, 46 and 47. When the user 1 selects these pieces of music, the names of the selected pieces of music and their artists are displayed on the selection box 41. When the user 1 presses the rental request button 42 with the names of the selected pieces of music and their artists displayed on the selection box 41, the screen jumps to a site of the provider 4 (by establishing a link 14). It should be noted that if the watching/listening request button 43 is pressed before the rental request button 42, the user 1 can hear sounds of the selected pieces of music in a streaming playback operation. If the user 1 presses the download button 44, the selected pieces of music are downloaded and stored in a non-volatile memory or the like employed in the user terminal. The user 1 is thus capable of listening to the downloaded music at any time from the user terminal provided with such a non-volatile memory.

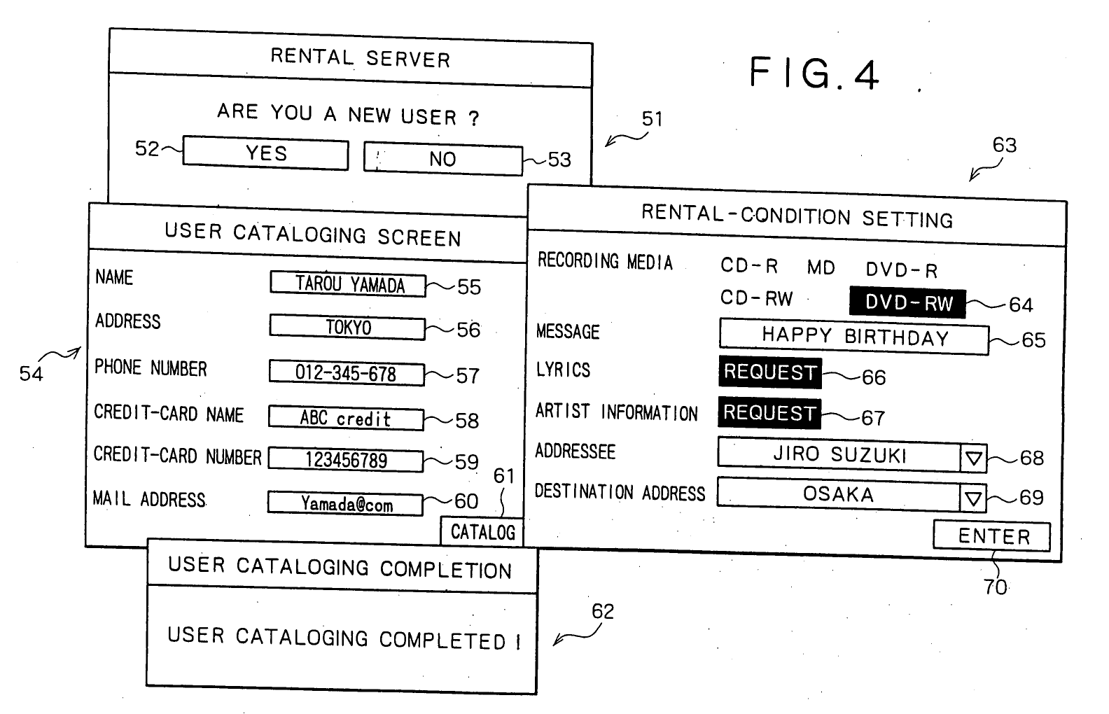

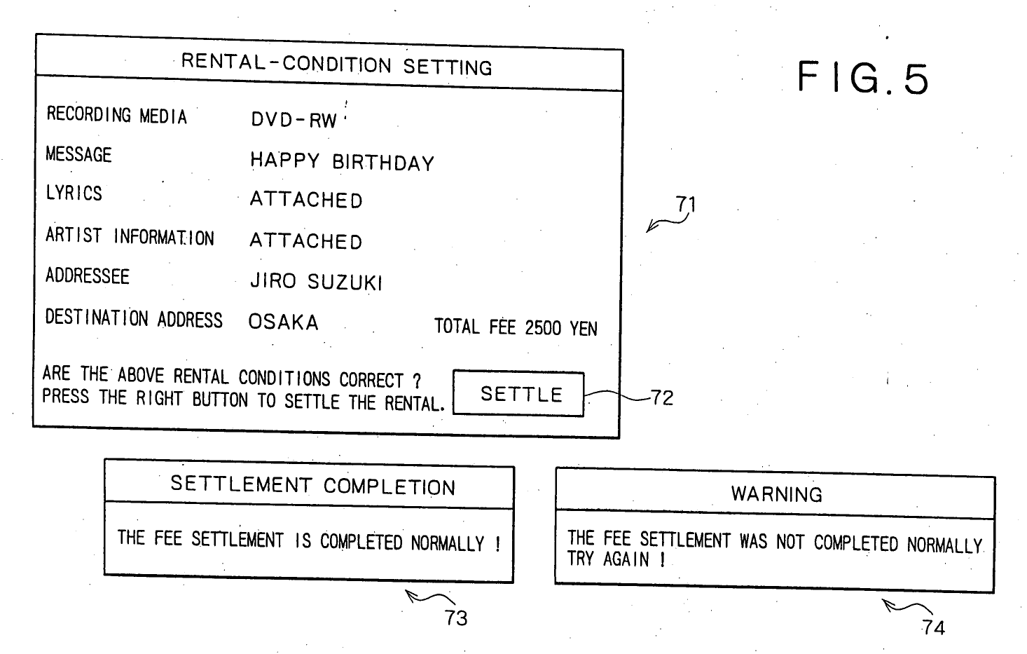

FIGS. 4 and 5 are diagrams showing typical home pages displayed on the user terminal as a result of establishment of the link 14 to the site of the rental server 4.

When the link 14 to the rental server.4 is established, first of all, a screen 51 is displayed. The screen 51 includes a YES button 52 and a NO button 53, which are used to confirm a new user.

If the user 1 presses the YES button 52, a user-cataloging screen 54 is displayed. The user-cataloging screen 54 is a screen for entering personal information on a user. Typically, the user-cataloging screen 54 includes a name input column 55, a postal-address input column 56, a telephone-number input column 57, a card-name input column 58, a card-number input column 59, a mail-address input column 60 and a catalog button 61.

Then, when the user 1 presses the catalog button 61 after pieces of personal information have been entered to the above-described input columns, a user-cataloging-completion screen 62 is displayed to inform the user 1 that user cataloging has been completed.

Subsequently, a rental-condition-setting screen 63 is displayed. The rental-condition-setting screen 63 is a screen for selecting and entering specifications of a content to be rented. Typically, the rental-condition-setting screen 63 includes a storage media select column 64, a message input column 65, a lyrics-card request 66, an artist-information request 67, a addressee-name-input column 68, a destination-address input column 69 and a confirm button 70.

From the storage media select column 64, the user 1 is allowed to select a CD-R (Compact Disk Recordable), a CD-RW (Compact Disk Rewritable), an MD (Mini Disc), a DVD-R (Digital Versatile Disk Recordable), a DVD-RW (Digital Versatile Disk Rewritable), a non-volatile memory or the like. Since the user 1 is allowed to select the desired type of storage media in this way, a song that is heretofore sold as a CD only can be listened to from the existing apparatus owned by the user 1. The apparatus can be an MD player, a DVD player or a playback player having a non-volatile memory. In addition, since the address of the destination can be specified, this rental system can be utilized in presenting a gift or placing a corporate advertisement.

If the user 1 wants to borrow various pieces of music, the user 1 is allowed to additionally enter requests for information on the pieces of music and their artists. In addition, besides the options such as a message and a lyrics card which are cited above, in this content rental system, the user 1 is also allowed to specify a request for an electronic music box, a request for a picture, a request for a special delivery, a delivery date and a request for a delivery as a registered parcel even though these additional options are not shown in the figure.

Then, when the user 1 presses the confirm button 70 after entering rental conditions to the select columns and the input columns as described above, a rental-condition-setting verification screen 71 is displayed. The rental-condition-setting verification screen 71 includes pieces of information for verifying the content, which have been set on the rental-condition-setting screen 63, and a total price of rented content set by the user 1. In addition, the rental-condition-setting verification screen 71 also includes a settlement button 72 for carrying out a fee settlement process.

Subsequently, when the user 1 presses the settlement button 72 after verifying the rental conditions of contents to be rented which appear on the rental-condition-setting verification screen 71, settlement information 15 is transmitted to the billing server 5.

The billing server 5 carries out a fee settlement process based on the settlement information 15. That is to say, the billing server 5 draws a deposit fee and a rental fee from a bank account of the user 1 (fee payment process 16). The deposit fee is deposited into the rental server 4 whereas the rental fee is distributed among the service provider 2, the content provider 3, the rental server 4 and the billing server 5. To put it concretely, a rental copyright fee 17 is paid to the rental server 4, a rented content handling fee 18 is paid to the content provider 3, a label-gate handling fee is paid to the service provider 2 and a settlement handling fee is paid to the billing server 5. The rented content handling fee 18 includes a delivery cost, a storage media packaging cost, a printing cost and the like. The remaining money of the rental fee after the distribution as described above is a profit.

If the fee settlement process is completed normally, a settlement-completion screen 73 is displayed on the user terminal. If the fee settlement process is not completed normally, on the other hand, a warning screen 74 is displayed on the user terminal.

If the fee settlement process is completed normally, musical data and lyrics data 19 are transmitted to the rental server 4 from the content provider 3. The rental server 4 records the musical data onto storage media selected by the user 1 through the rental-condition-setting screen 63 and prints lyrics on a package based on the lyrics data. In addition, the rental server 4 also prints a destination address, a message, a bar code and the like, which are based on information set in the rental-condition-setting screen 63, on the package provided specially for the storage media. The package provided specially for the storage media is sent to the post office 6 (rented content shipping process 20). The bar code includes a user ID for identifying a user and a content ID for identifying a content.

The post office 6 receives the rented content from the rental server 4 and reads out the bar code printed on the package. The post office 6 then stores the information of the bar code into a database and sends the package to the user 1 (rented content delivery process 21).

The user 1 plays back the received storage media by using an apparatus such as a CD player, an MD player or a DVD player to listen to the music. After listening to the music, the user 1 sends back the storage media through a nearest post office 6 (rented content-returning process 22).

In the post office 6, a bar-code reader reads out the bar code from a parcel containing the storage media returned by the user and automatically forms a judgment as to whether or not the rented content is returned within a rental period on the basis of data stored in a database. Information included in the bar code is transferred to the rental server 4 at the same time as the bar code is read out from the parcel (bar-code-information transfer process 23).

If the rented content is returned within a rental period, the post office 6 delivers the parcel containing the rented content to the rental server 4. If the rented content is returned after the rental period, on the other hand, the post office 6 returns the parcel containing the rented content to the user 1. That is to say, the user 1 must automatically purchase the rented content (rented content-purchasing process 24).

The rental server 4 is thus capable of obtaining a receiving date, a return due date and overdue-purchase information instantaneously from the bar-code information sent from the post office 6.

If the information indicates that the rented content is being returned, money of an amount obtained as a result of subtraction of a settlement-company handling fee from money deposited in the rental server 4 in advance is refunded to the bank account of the user 1 (deposit-fee refund process 25).

If the information indicates that the rented content is automatically purchased by the user 1, on the other hand, a difference obtained as a result of subtraction of a handling fee charged by a fee-settlement company from an amount of money deposited in the billing server 5 in advance is distributed between the content provider 3 and the rental server 4. In this case, a fee paid to the content provider 3 is a fee paid in the purchase of the rented content for the copyright of the author (purchased-copyright fee-payment process 26).

In addition, the returned rented content is reused in order to reduce the number of environmental trashes. That is to say, the package of the returned content is recycled into paper and the storage medium is initialized for reutilization. However, a CD-R and a DVD-R are recycled into reproduction of poly-carbonate.

It should be noted that the rental system described above includes data-copying sites scattered throughout a number of states all over the country. Thus, when the user 1 places an order for a content to be rented, the rented content is delivered from a site closest to the user 1. As a result, in this rental system, a rented content can be delivered to the user 1 on a day following the day an order for the rented content is placed.

The content rental system described above is a system embracing serial copy management. That is to say, since a storage medium of a rented content is a disk containing digital copies, the storage medium should be rented to only users capable of copying only analog data. However, the content rental system can also be implemented as a system wherein digital copying is permitted only once from a rented CD to an MD.

The following description explains configurations of the user terminal, the service provider 2, the content provider 3, the rental server 4, the billing server 5 and the post office 6.

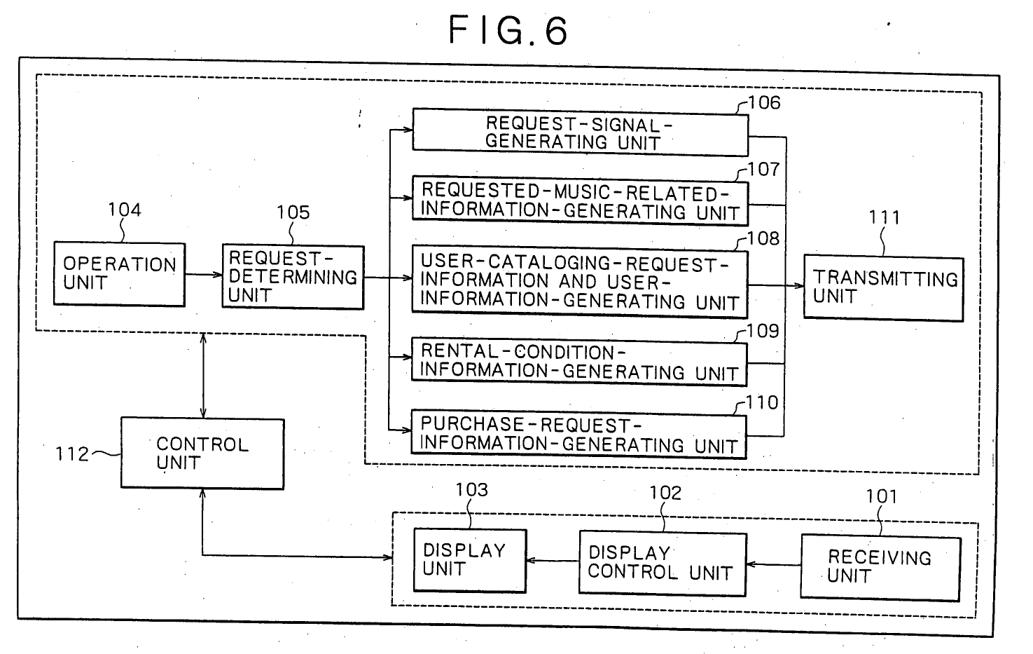

As shown in FIG. 6, the user terminal comprises a receiving unit 101, a display control unit 102, a display unit 103, an operation unit 104, a request-determining unit 105, a request-signal-generating unit 106, a requested-music-related-information-generating unit 107, a user-cataloging-request-information and user-information-generating unit 108, a rental-condition-information-generating unit 109, a purchase-request-information-generating unit 110, a transmitting unit 111 and a control unit 112.

The receiving unit 101 receives a signal transmitted through the Internet and supplies the signal to the display control unit 102. The display control unit 102 supplies the signal received from the receiving unit 101 to the display unit 103. The display unit 103 outputs a display based on the signal received from the display control unit 102.

Operated by the user 1, the operation unit 104 is a keyboard or operation buttons. The request-determining unit 105 recognizes an operation carried out on the operation unit 104 and generates a signal representing the operation.

The request-signal-generating unit 106 generates a request signal based on the signal received from the request-determining unit 105 and supplies the request signal to the transmitting unit 111 to be transmitted to the service provider 2 or the content provider 3. The request signal transmitted to the service provider 2 is a signal for requesting the service provider 2 to provide music-related information. On the other hand, the request signal (rental-request information) transmitted to the content provider 3 is a signal for requesting the content provider 3 to provide a rented content.

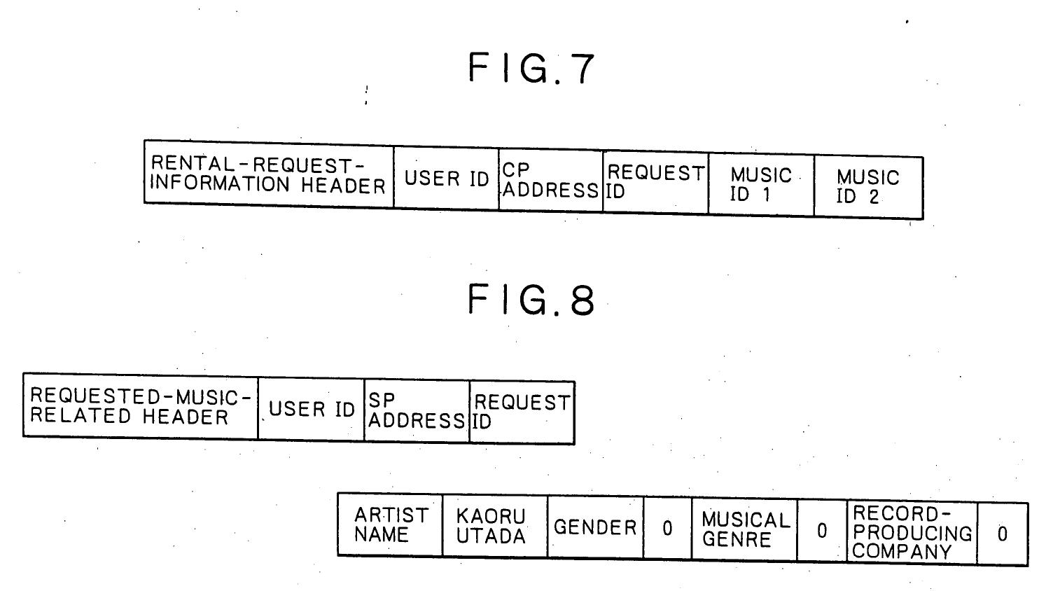

FIG. 7 is a typical structure of the rental-request information. As shown in FIG. 7, the rental-request information includes a rental-request-information header, a user ID, a CP address, a request ID and music IDs. The rental-request-information header is provided for identifying the beginning of the rental-request information and the user ID is a code for identifying the user 1. The CP address is the address of the content provider 3 whereas the request ID is a code for identifying a request. The music IDs are each a code for identifying a piece of music.

The requested-music-related-information-generating unit 107 generates information related to requested pieces of music on the basis of a signal received from the request-determining unit 105 and supplies the information to the transmitting unit 111. The information related to requested pieces of music is information for requesting the service provider 2 to generate information related to requested pieces of music.

FIG. 8 is a diagram showing a typical structure of the information related to requested pieces of music. As shown in FIG. 8, the information related to requested pieces of music comprises a requested-music-related header, a user ID, an SP address, a request ID, an artist name, a gender, a musical genre and the name of a record-producing company. The requested-music-related header is provided for identifying the beginning of the requested-music-related information and the SP address is the address of the service provider.

The user-cataloging-request-information and user-information-generating unit 108 generates user-cataloging-request information or user information, which are based on a signal generated by the request-determining unit 105, and supplies the information to the transmitting unit 111. The user-cataloging-request-information is information for requesting the rental server 4 to catalog the user. The user information is a new user's personal information to be transmitted to the rental server 4. The user information typically includes the name of the user 1, the postal address, the phone number, the card name and the email address.

The rental-condition-information-generating unit 109 generates information on rental conditions based on the signal received from the request-determining unit 105 and supplies the information to the transmitting unit 111. The information on rental conditions is used for generating rental conditions desired by the user 1 and transmitted to the rental server 4. Typically, the information on rental conditions includes information on a storage medium for copying musical information, a message, lyrics and the name as well as the address, of the recipient of the storage medium which are printed on a package to be described later.

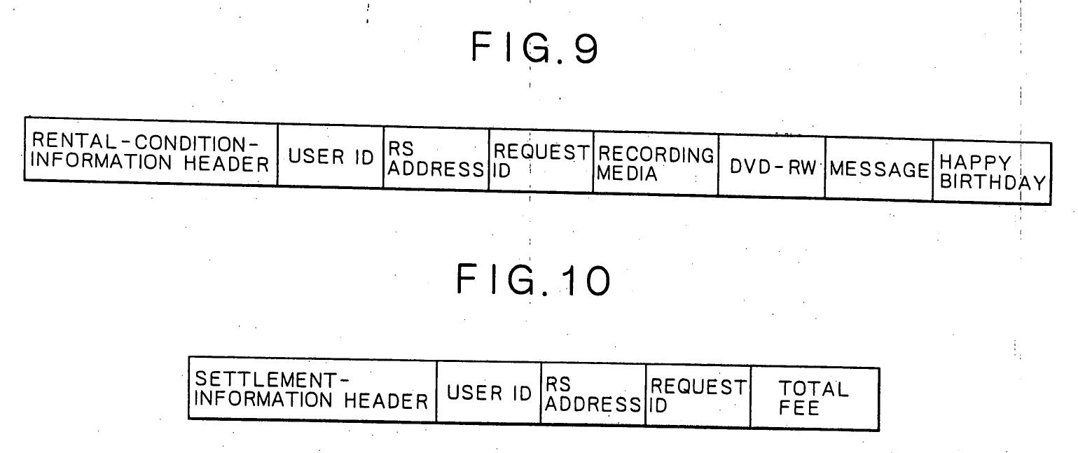

FIG. 9 is a diagram showing a typical structure of the information on rental conditions. As shown in the figure, the information on rental conditions includes a rental-condition-information header, a user ID, an RS address, a request ID, storage media information and message information. The rental-condition-information header is provided for recognizing the beginning of the rental-condition information and the RS address is the address of the rental server 4.

The purchase-request-information-generating unit 110 generates information on a purchase request-based on the signal received from the request-determining unit 105. The information on a purchase request is information for making a request for renting of a content to be rented and transmitted to the rental server 4.

FIG. 10 is a diagram showing a typical structure of information on a settlement. As shown in the figure, the information on a settlement comprises a settlement-information header, a user ID, an RS address, a request ID and total fee information. The settlement-information header is provided for recognizing the beginning of the information on a settlement and the RS address is the address of the rental server 4.

The transmitting unit 111 passes on signals received from a variety of units employed in the user terminal to the service provider 2, the content provider 3, the rental server 4 or the billing server 5 by way of the Internet. The control unit 112 controls the units employed in the user terminal.

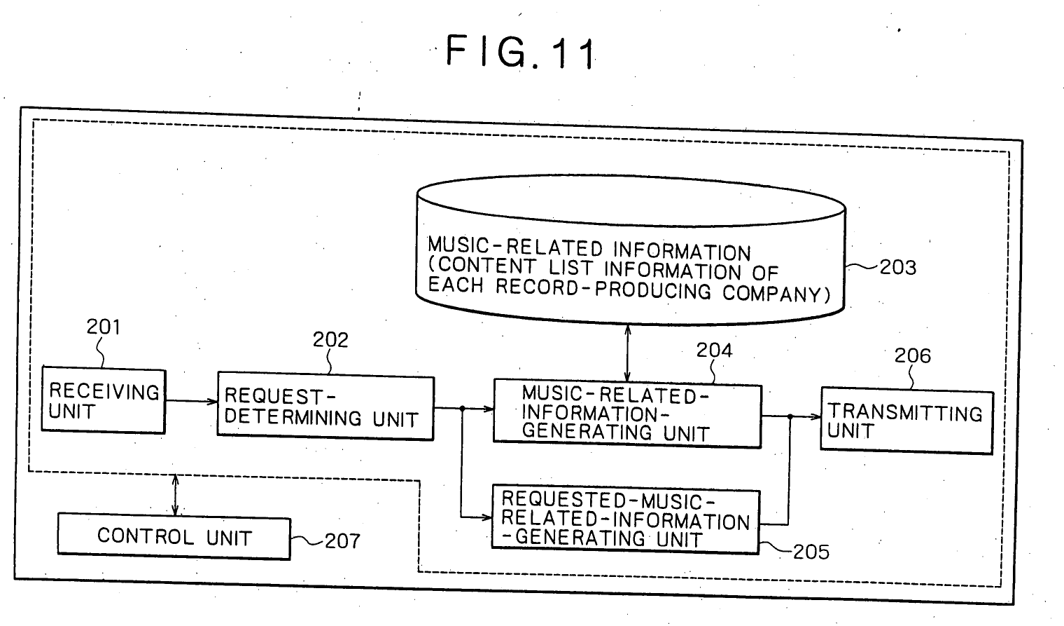

As shown in FIG. 11, the service provider 2 comprises a receiving unit 201, a request-determining unit 202, a storage unit 203, a music-related-information-generating unit 204, a requested-music-related-information-generating unit 205 and a transmitting unit 206 and a control unit 207.

The receiving unit 201 receives a signal transmitted through the Internet and supplies the signal to the request-determining unit 202. The request-determining unit 202 forms a judgment on the signal supplied from the receiving unit 201 and outputs a signal based on a result of the judgment to the music-related-information-generating unit 204 or the requested-music-related-information-generating unit 205. To be more specific, if the result of the judgment indicates that information on a request has been received, the request-determining unit 202 supplies the signal to the music-related-information-generating unit 204. If the result of the judgment indicates that information related to a requested-music, on the other hand, the request-determining unit 202 supplies the signal to the requested-music-related-information-generating unit 205.

The storage unit 203 is used for storing music-related information. An example-of the music-related information is a list of contents produced by each record-producing company.

The music-related-information-generating unit 204 extracts music-related information based on a signal supplied from the request-determining unit 202 from the storage unit 203 and supplies the information to the transmitting unit 206.

On the other hand, the requested-music-related-information-generating unit 205 generates requested-music-related information based on a signal supplied from the request-determining unit 202 and supplies the information to the transmitting unit 206.

The transmitting unit 206 transmits the signals supplied from the music-related-information-generating unit 204 and the requested-music-related-information-generating unit 205 to the user terminal or the content provider 3 by way of the Internet. The control unit 207 controls the units employed in the service provider 2.

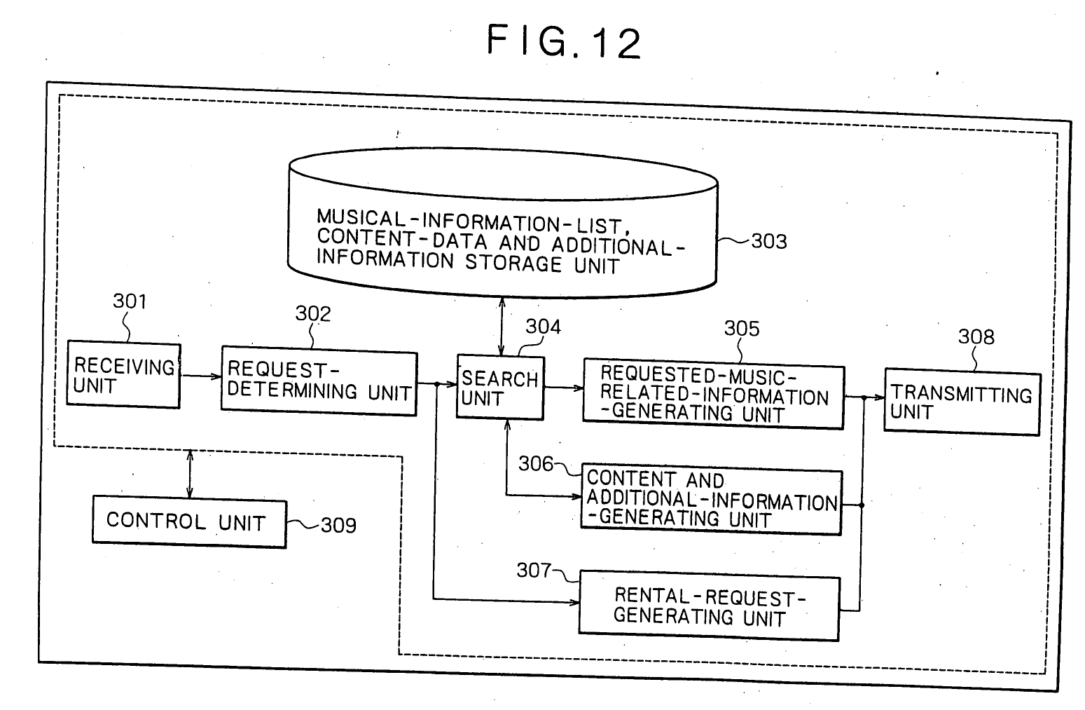

As shown in FIG. 12, the content provider 3 comprises a receiving unit 301, a request-determining unit 302, a storage unit 303, a search unit 304, a requested-music-related-information-generating unit 305, a content and additional-information-generating unit 306, a rental-request-generating unit 307, a transmitting unit 308 and a control unit 309.

The receiving unit 301 receives a signal transmitted through the Internet and supplies the signal to the request-determining unit 302. The request-determining unit 302 forms a judgment on the signal received from the receiving unit 301 and outputs a signal based on a result of the judgment to the requested-music-related-information-generating unit 305, the content and additional-information-generating unit 306 or the rental-request-generating unit 307. To be more specific, the request-determining unit 302 supplies information related to a requested music to the requested-music-related-information-generating unit 305, a requested content ID to the content and additional-information-generating unit 306 and a rental request to the rental-request-generating unit 307.

The storage unit 303 is used for storing musical-information lists, content data, additional information and others. A musical-information list is information used for displaying a list of musical pieces on the user terminal. The content data is musical data. The additional information includes a lyrics card and a table of contents.

The search unit 304 searches the storage unit 303 on the basis of a signal received from the requested-music-related-information-generating unit 305 or the content and additional-information-generating unit 306. The requested-music-related-information-generating unit 305 also searches the storage unit 303 through the search unit 304 on the basis of requested-music-related information received from the request-determining unit 302, and supplies a result of the search to the transmitting unit 308. The content and additional-information-generating unit 306 searches the storage unit 303 on the basis of a requested-content ID received from the request-determining unit 302, and supplies a result of the search to the transmitting unit 308.

The rental-request-generating unit 307 generates a rental request and supplies the request to the transmitting unit 308. The transmitting unit 308 transmits a signal received thereby to the user terminal, the service provider 2 or the rental server 4 through the Internet. The control unit 309 controls the units employed in the content provider 3.

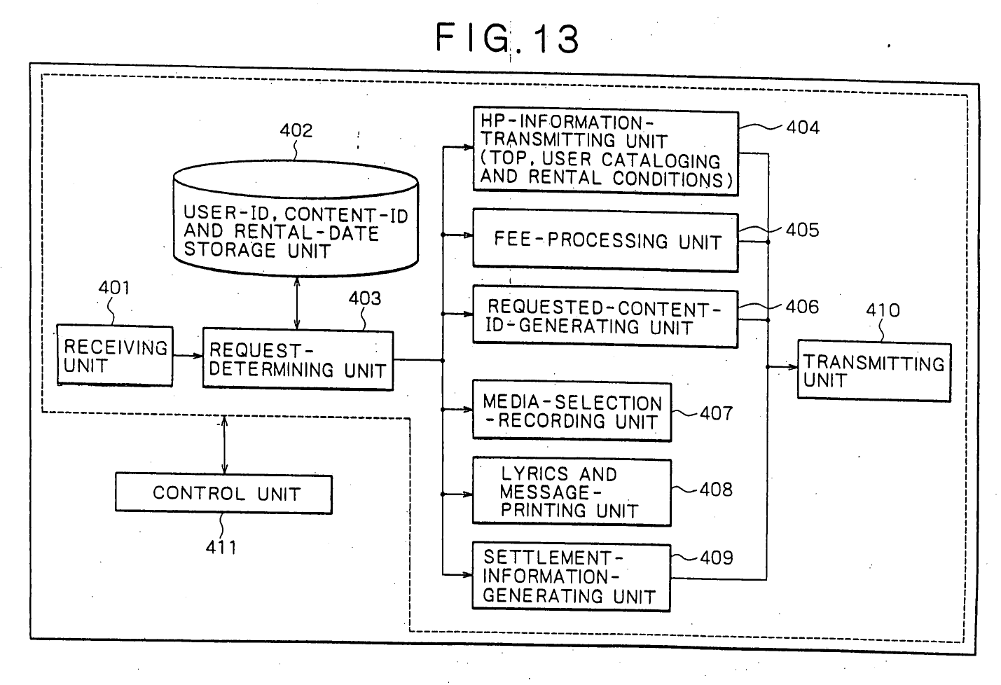

As shown in FIG. 13, the rental server 4 comprises a receiving unit 401, a storage unit 402, a request-determining unit 403, a home-page-information-transmitting unit 404, a fee-processing unit 405, a requested-content-ID-generating unit 406, a media-selection-recording unit 407, a lyrics and message-printing unit 408, a settlement-information-generating unit 409, a transmitting unit 410 and a control unit 411.

The receiving unit 401 receives a signal transmitted through the Internet and supplies the signal to the request-determining unit 403. The request-determining unit 403 forms a judgment on the signal received from the receiving unit 401 and supplies-a signal based on a result of the judgment.

The storage unit 402 is used for storing user IDs, content IDs (or music IDs) and rental dates. The home-page-information-transmitting unit 404 generates home-page information to be transmitted to the user terminal, and supplies the information to the transmitting unit 410. Examples of the home-page information are home-page information used for displaying a top page screen, home-page information used for displaying a user-cataloging screen and home-page information used for displaying a rental-condition screen.

The fee-processing unit 405 processes a fee based on information on rental conditions, as well as generates rental-condition-setting verification information and supplies the rental-condition-setting verification information to the transmitting unit 410. The rental-condition-setting verification information includes a result of fee processing and information for verifying rental conditions of a content to be rented. It should be noted that a basic fee system of a rented content will be explained later.

The requested-content-ID-generating unit 406 generates the ID of a requested content and transmits the ID to the content provider 3 by way of the transmitting unit 410, requesting the content provider 3 to provide data of the requested content and additional information.

The media-selection-recording unit 407 selects a storage medium based on storage-medium information included in the information on rental conditions, and records data of contents onto the selected storage medium. In addition, the media-selection-recording unit 407 also determines whether to record data of contents onto a storage medium having a 8-cm size or a storage medium having a 12-cm size in dependence on the amount of the data to be recorded. Thus, the delivery cost can be reduced for data of a small amount.

The lyrics and message-printing unit 408 prints a message, lyrics and a recipient on a package to be shown later on the basis of the information on rental conditions and the additional information.

The settlement-information-generating unit 409 generates information on a settlement on the basis of a signal received from the request-determining unit 403, and supplies the information to the transmitting unit 410. The information on a settlement is transmitted to the billing server 5. The information on a settlement is used for paying a rental fee charged by refunding a deposit or for apportioning a deposit.

The transmitting unit 410 transmits a signal received from the home-page-information-transmitting unit 404, the fee-processing unit 405 or the requested-content-ID-generating unit 406 to the user terminal, the content provider 3 or the post office 6 by way of the Internet. The control unit 411 controls the units employed in the rental server 4.

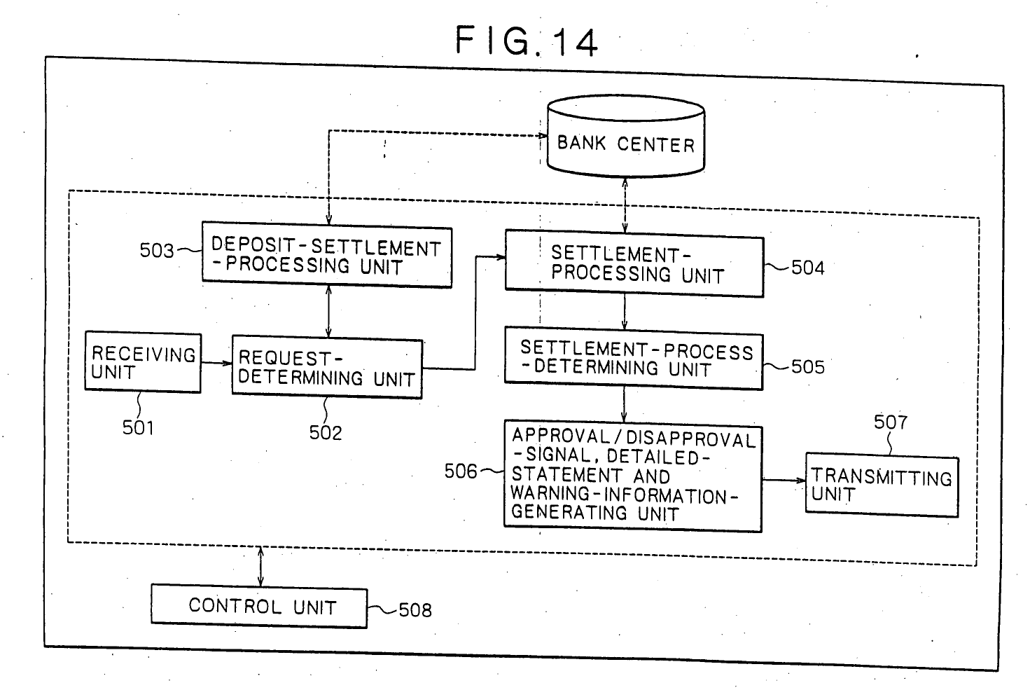

As shown in FIG. 14, the billing server 5 comprises a receiving unit 501, a request-determining unit 502, a deposit-settlement-processing unit 503, a settlement-processing unit 504, a settlement-process-determining unit 505, an approval/disapproval-signal, detailed-statement and warning-information-generating unit 506, a transmitting unit 507 and a control unit 508.

The receiving unit 501 receives a signal transmitted through the Internet and supplies the signal to the request-determining unit 502. The request-determining unit 502 forms a judgment on the signal received from the receiving unit 501 and outputs a signal based on a result of the judgment to the deposit-settlement-processing unit 503 and the settlement-processing unit 504. To put it in detail, the request-determining unit 502 supplies settlement information for refunding a deposit as well as settlement information for apportioning a deposit to the deposit-settlement-processing unit 503 and settlement information used for a rental purpose to the settlement-processing unit 504.

The deposit-settlement-processing unit 503 carries out fee settlement processing based on fee settlement information received from the request-determining unit 502. That is to say, if the deposit-settlement-processing unit 503 receives fee settlement information for refunding a deposit, the deposit-settlement-processing unit 503 carries out fee settlement processing to refund an amount of money equal to a difference obtained as a result of subtraction of a fee charged by a card company from a sum of money deposited in the card company in advance to a bank account of the user 1. If the deposit-settlement-processing unit 503 receives fee settlement information for apportioning a deposit, on the other hand, the deposit-settlement-processing unit 503 carries out fee settlement processing to apportion an amount of money equal to a difference obtained as a result of subtraction of a fee charged by a card company from a sum of money deposited in the card company in advance among the record-producing company, the rental company and others.

The settlement-processing unit 504 carries out fee settlement processing based on a signal received from the request-determining unit 502. The settlement-process-determining unit 505 forms a judgment as to whether or not processing has been carried out normally by the settlement-processing unit 504 on the basis of a signal supplied by the settlement-processing unit 504.

The approval/disapproval-signal, detailed-statement and warning-information-generating unit 506 supplies an approval signal or a disapproval signal, information on details and a warning to the transmitting unit 507.

The transmitting unit 507 transmits a signal generated by the approval/disapproval-signal, detailed-statement and warning-information-generating unit 506 to the user terminal by way of the Internet.

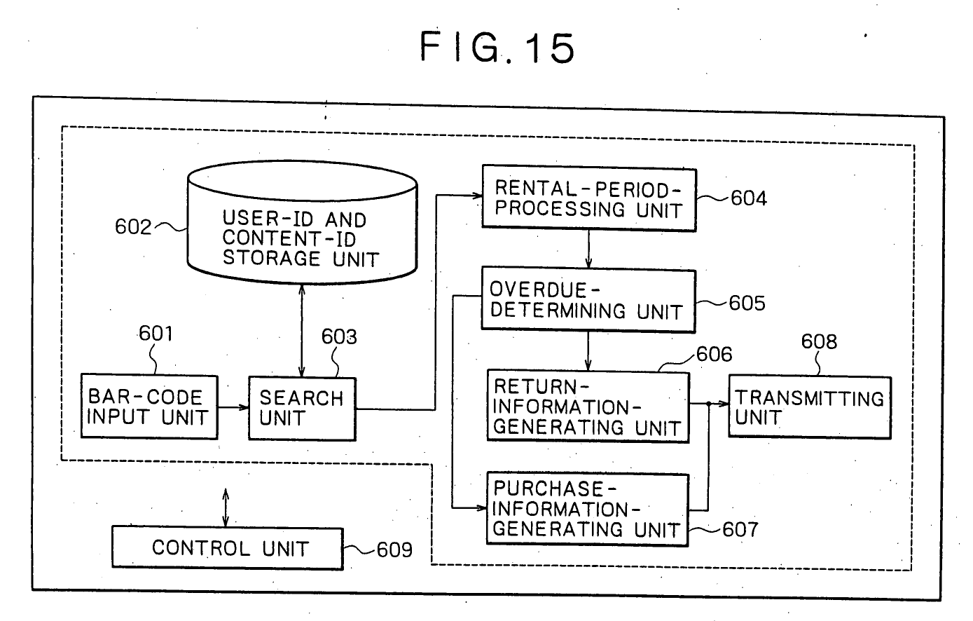

As shown in FIG. 15, the post office 6 comprises a bar-code input unit 601, a storage unit 602, a search unit 603, a rental-period-processing unit 604, an overdue-determining unit 605, a return-information-generating unit 606, a purchase-information-generating unit 607 and a transmitting unit 608 and a control unit 609.

The bar-code input unit 601 reads in a bar code printed on a package of a rented content to be shown later. The bar code includes typically a user ID and a content ID (or a music ID). The storage unit 602 is used for storing user IDs and content IDs (or music IDs).

The search unit 603 searches the storage unit 602 for a user ID and a content ID based on a signal received from the bar-code input unit 601, extracting the user ID and the content ID from the storage unit 602. If the user ID and the content ID that correspond to the signal received from the bar-code input unit 601 do not exist in the storage unit 602, the user ID and the content ID which are included in the bar code are stored in the storage unit 602 along with a rental date of a storage medium.

It should be noted that, in case a rental application is made at dead of night, the morning of the following day is taken as the rental date. This is because, while the Internet allows a rental application to be made 24 hours a day, a rented content is basically delivered by mail during normal working hours. If a rental application is made on a Saturday or Sunday, the following Monday is taken as the rental date. However, a special delivery is an exception.

The rental-period-processing unit 604,processes a rental period based on a rental date of a storage medium extracted by the search unit 603.

The overdue-determining unit 605 forms a judgment as to whether or not a returned-storage medium is overdue on the basis of a processing result produced by the rental-period-processing unit 604. To put it in detail, the overdue-determining unit 605 outputs a signal to the return-information-generating unit 606 if the outcome of the judgment indicates that the returned storage medium is not overdue. If the outcome of the judgment indicates that the returned storage-medium is overdue, on the other hand, the overdue-determining unit 605 outputs a signal to the purchase-information-generating unit 607.

Typically, the overdue-determining unit 605 counts the number of days starting with the rental date and ending with today. If the number of days is smaller than 8, the overdue-determining unit 605 determines that the storage medium is not overdue yet. If the number of days is greater than 8, on the other hand, the overdue-determining unit 605 determines that the storage medium is already overdue.

The return-information-generating unit 606 generates return information based on a signal received from the overdue-determining unit 605 and supplies the return information to the transmitting unit 608. The return information is information for informing the rental server 4 that the rented content has been returned.

The purchase-information-generating unit 607 generates purchase information based on a signal received from the overdue-determining unit 605 and supplies the purchase information to the transmitting unit 608. The purchase information is information for informing the rental server 4 that the user 1 should purchase the rented content.

The transmitting unit 608 transmits the return information or the purchase information received thereby to the rental server 4. The control unit 609 controls the units employed in the post office 6.

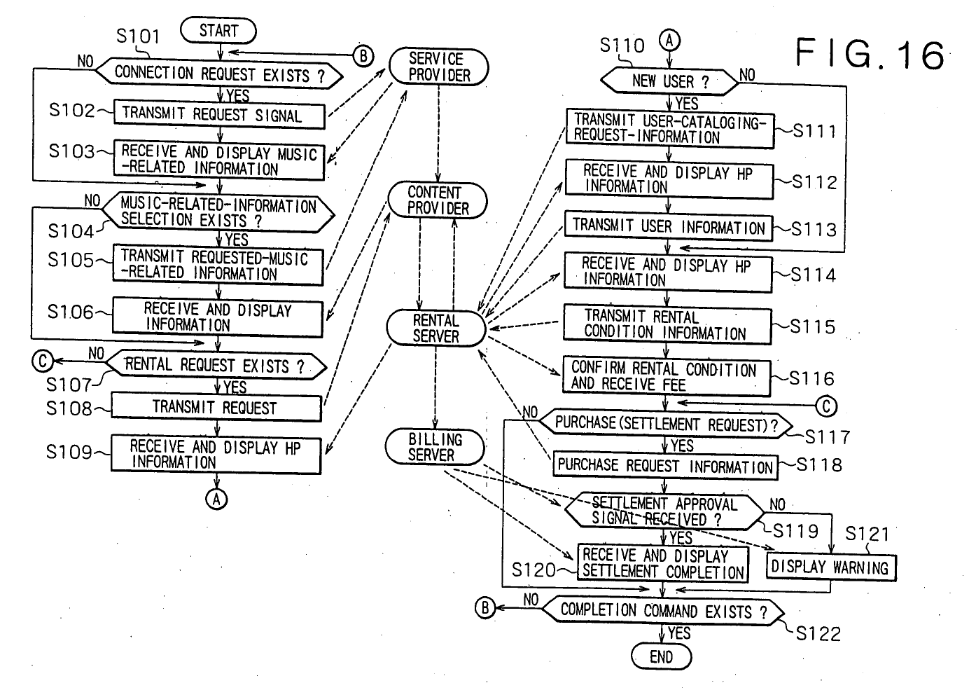

FIG. 16 is a flowchart used for explaining processing carried out by the user terminal.

The flowchart begins with a step S101 at which the request-determining unit 105 forms a judgment as to whether or not a request for a connection to the service provider 2 has been made. If such a request has been made, the flow of the processing goes on to a step S102 at which the request-signal-generating unit 106 generates a request signal and transmits the signal to the service provider 2 by way of the transmitting unit 111.

Then, at the next step S103, music-related information according to the request signal transmitted at the step S102 is received by the receiving unit 101 and processed by the display control unit 102 to be output to the display unit 103.

Subsequently, at the next step S104, the request-determining unit 105 forms a judgment as to whether or not music-related information has been selected. If music-related information has been selected, the flow of the processing goes on to a step S105 at which the requested-music-related-information-generating unit 107 generates a signal representing the requested music-related information and transmits the signal to the service provider 2 by way of the transmitting unit 111.

Then, at the next step S106, the requested music-related information is received by the receiving unit 101 from the content provider 3 and processed by the display control unit 102 to be output to the display unit 103.

Subsequently, at the next step S107, the request-determining unit 105 forms a judgment as to whether or not a rental request has been made. If a rental request has been made, the flow of the processing goes on to a step S108 at which the request-signal-generating unit 106 generates a request signal and transmits the signal to the content provider 3 by way of the transmitting unit Then, at the next step S109, home-page information is received by the receiving unit 101 from the rental server 4 and processed by the display control unit 102 to be output to the display unit 103. This home-page information is home-page information used for displaying a top-page screen.

Subsequently, at the next step S110, the request-determining unit 105 forms a judgment as to whether or not the operation unit 104 has been operated to catalog a new user. If an operation has been operated to catalog a new user, the flow of the processing goes on to a step Sill at which the user-cataloging-request-information and user-information-generating unit 108 generates user-cataloging-request information and transmits the information to the rental server 4 by way of the transmitting unit 111.

Then, at the next step S112, home-page information is received by the receiving unit 101 from the rental server 4 and processed by the display control unit 102 to be output to the display unit 103. This home-page information is home-page information used for displaying a user-cataloging screen.

Subsequently, at the next step S113, the user-cataloging-request-information and user-information-generating unit 108 generates user information and transmits the information to the rental server 4 by way of the transmitting unit 111.

Then, at the next step S114, home-page information is received by the receiving unit 101 from the rental server 4 and processed by the display control unit 102 to be output to the display unit 103. This home-page information is home-page information used for displaying a screen of rental conditions.

Subsequently, at the next step S115, the rental-condition-information-generating unit 109 generates information on rental conditions and transmits the information to the rental server 4 by way of the transmitting unit 111.

Then, at the next step S116, rental-condition-setting verification information is received by the receiving unit 101 from the rental server 4 and processed by the display control unit 102 to be output to the display unit 103.

Subsequently, at the next step S117, the request-determining unit 105 forms a judgment as to whether or not the operation unit 104 has been operated by the user 1 to purchase the rented content. If the operation unit 104 has been operated to purchase the rented content, the flow of the processing goes on to a step S118 at which the purchase-request-information-generating unit 110 generates purchase-request information and transmits the information to the rental server 4 by way of the transmitting unit 111.

Then, at the next step S119, a settlement approval signal is received by the receiving unit 101 from the billing server 5 and processed by the display control unit 102 to be output to the display unit 103.

When the settlement approval signal is received, a detailed-information signal is received by the receiving unit 101 from the billing server 5 and processed by the display control unit 102 to be output to the display unit 103 at a step S120.

If the received settlement approval signal is a disapproval signal, on the other hand, a warning is received by the receiving unit 101 from the billing server 5 and processed by the display control unit 102 to be output to the display unit 103 at a step 121.

Subsequently, the flow of the processing goes to a step S122 to form a judgment as to whether or not a termination command has been received. If a termination command has been received, the processing is ended. If a termination command has not been received, on the other hand, the flow of the processing goes back to the step S101.

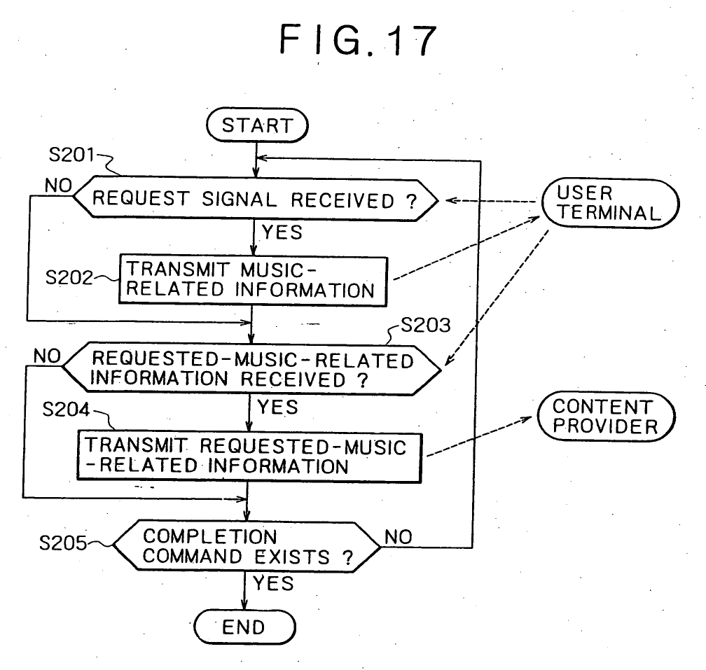

FIG. 17 is a flowchart used for explaining processing carried out by the service provider 2.

The flowchart begins with a step S201 at which the request-determining unit 202 forms a judgment as to whether or not a request signal has been received from the user terminal. If such a request signal has been received, the flow of the processing goes on to a step S202 at which the music-related-information-generating unit 204 generates music-related information and transmits the information to the user terminal by way of the transmitting unit 206.

Then, at the next step S203, the request-determining unit 202 forms a judgment as to whether or not information related to requested music has been received from the user terminal. If information related to requested music has been received from the user terminal, the flow of the processing goes on to a step S204 at which the requested-music-related-information-generating unit 205 generates information related to requested music and transmits the information to the content provider 3 by way of the transmitting unit 206.

The flow of the processing then goes on to a step S205 to form a judgment as to whether or not a termination command has been received. If a termination command has been received, the processing is ended If a termination command has not been received, on the other hand, the flow of the processing goes back to the step S201.

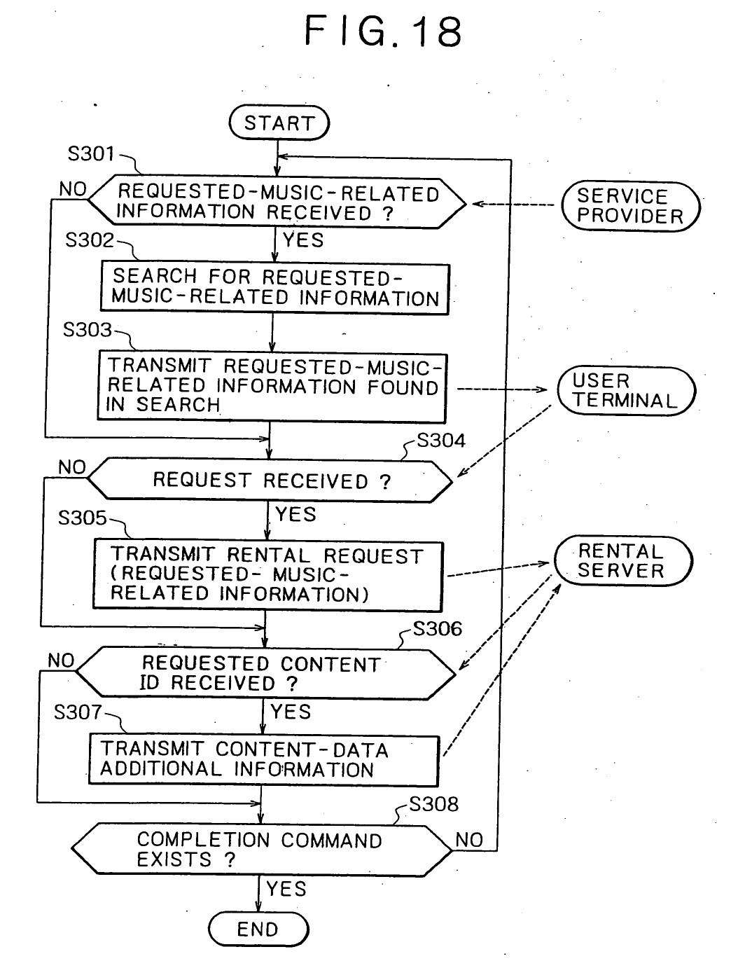

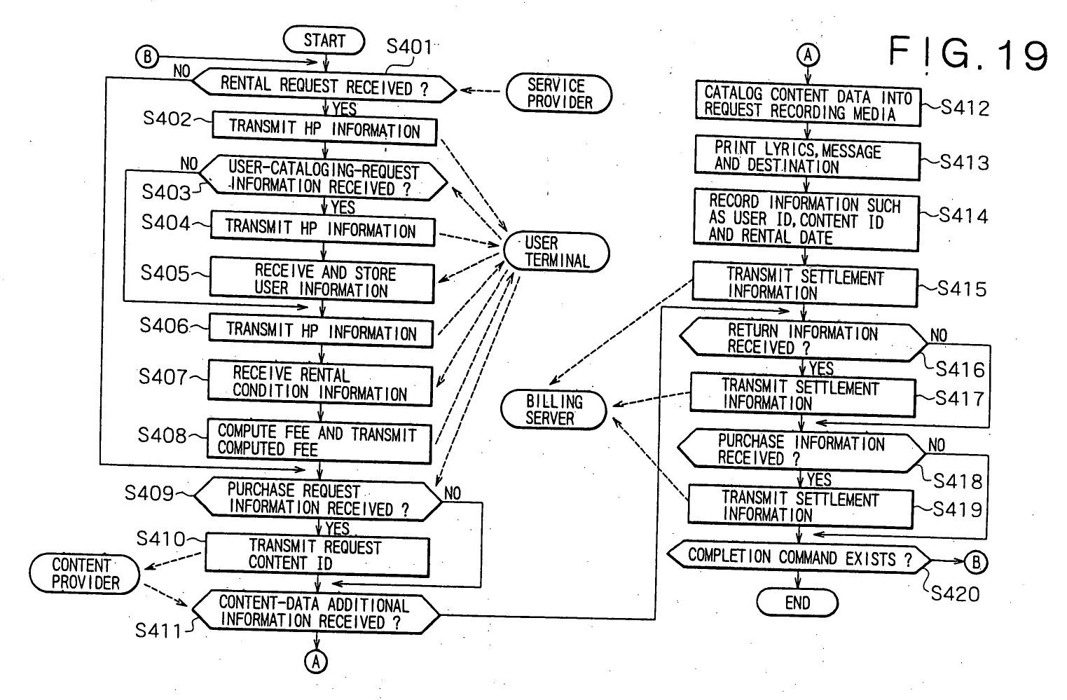

FIG. 18 is a flowchart used for explaining processing carried out by the content provider 3.

The flowchart begins with a step S301 at which the request-determining unit 302 forms a judgment as to whether or not a received signal is information related to requested music. If the outcome of the judgment indicates that the received signal is information related to requested music, the flow of the processing goes on to a step S302 at which the requested-music-related-information-generating unit 305 searches for information related to requested music. Then, at the next step S303, the requested-music-related-information-generating unit 305 transmits the information-related to the requested music to the user terminal by way of the transmitting unit 308.

Subsequently, at the next step S304, the request-determining unit 302 forms a judgment as to whether or not a received signal is a request signal. If the outcome of the judgment indicates that the received signal is a request signal, the flow of the processing goes on to a step S305 at which the rental-request-generating unit 307 generates a rental request (information related to requested music) and transmits the request to the rental server 4 by way of the transmitting unit 308.

Then, at the next step S306, the request-determining unit 302 forms a judgment as to whether or not a received signal is a rental signal. If the outcome of the judgment indicates that the received signal is a rental signal, the flow of the processing goes on to a step S307 at which the content and additional-information-generating unit 306 generates content data as well as additional information and transmits the content data as well as the additional information to the rental server 4 by way of the transmitting unit 308.

The flow of the processing then goes on to a step S308 to form a judgment as to whether or not a termination command has been received. If a termination command has been received, the processing is ended If a termination command has not been received, on the other hand, the flow of the processing goes back to the step S301.

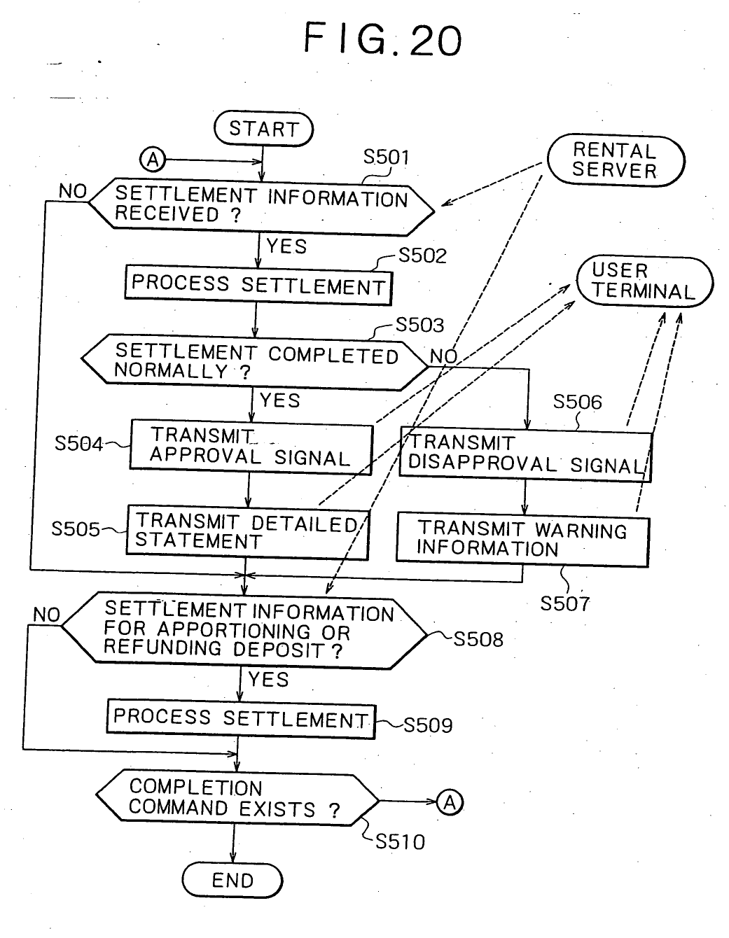

FIG. 19 is a flowchart used for explaining processing carried out by the rental server 4.

The flowchart begins with a step S401 at which the request-determining unit 403 forms a judgment as to whether or not a received signal is a rental request. If the outcome of the judgment indicates that the received signal is a rental request, the flow of the processing goes on to a step S402 at which the home-page-information-generating unit 404 generates home-page information used for displaying a screen showing a top page and transmits the information to the user terminal by way of the transmitting unit 410.

Then, at the next step S403, the request-determining unit 403 forms a judgment as to whether or not a received signal is user-cataloging-request information. If the outcome of the judgment indicates that the received signal is user-cataloging-request information, the flow of the processing goes on to a step S404 at which the home-page-information-generating unit 404 generates home-page information used for displaying a user-cataloging screen and transmits the information to the user terminal by way of the transmitting unit 410.

Subsequently, at the next step S405, user information is received by the receiving unit 401 from the user terminal, identified by the request-determining unit 403 and stored in the storage unit 402.

Next, at the next step S406, the home-page-information-transmitting unit 404 generates home-page information used for displaying a rental-condition screen and transmits the information to the user terminal by way of the transmitting unit 410.

Subsequently, at the next step S407, rental-condition information is received by the receiving unit 401, verified by the request-determining unit 403 to be rental-condition information and-supplied to the fee-processing unit 405.

Next, at the next step S408, the fee-processing unit 405 processes a fee based on the rental-condition information received thereby and transmits rental-condition-setting information to the user terminal by way of the transmitting unit 410.

Subsequently, at the next step S409, the request-determining unit 403 forms a judgment as to whether or not a received signal is purchase-request information. If the outcome of the judgment indicates that the received signal is purchase-request information, the flow of the processing goes on to a step S410 at which the requested-content-ID-generating unit 406 generates the ID of a requested content and transmits the ID to the content provider 3 by way of the transmitting unit 410.

Next, at the next step S411, the request-determining unit 403 forms a judgment as to whether or not a received signal is content data and additional information. If the outcome of the judgment indicates that the received signal is content data and additional information, the flow of the processing goes on to a step S412 at which the media-selection-recording unit 407 selects a storage medium on the basis of the rental-condition information and records the content data onto the selected storage medium.

Subsequently, at the next step S413, the lyrics and message-printing unit 408 prints lyrics, a message and the address of the destination, which are based on the rental-condition information and the additional information, on a package specially provided for the storage medium.

Next, at the next step S414, information including a user ID, a content ID and a rental date is stored in the storage unit 402.

Subsequently, at the next step S415, the settlement-information-generating unit 409 generates settlement information for settling a rental fee and transmits the information to the billing server 5 by way of the transmitting unit 410.

Next, at the next step S416, the request-determining unit 403 forms a judgment as to whether or not a received signal is return information transmitted by the post office 6. If the outcome of the judgment indicates that the received signal is return information, the flow of the processing goes on to a step S417 at which the settlement-information-generating unit 409 generates settlement information for refunding a deposit and transmits the information to the billing server 5 by way of the transmitting unit 410.

Next, at the next step S418, the request-determining unit 403 forms a judgment as to whether or not a received signal is purchase information. If the outcome of the judgment indicates that the received signal is purchase information, the flow of the processing goes on to a step S419 at which the settlement-information-generating unit 409 generates settlement information for apportioning a deposit and transmits the information to the billing server 5 by way of the transmitting unit 410.

The flow of the processing then goes on to a step S420 to form a judgment as to whether or not a termination command has been received. If a termination command has been received, the processing is ended. If a termination command has not been received, on the other hand, the flow of the processing goes back to the step S401.

FIG. 20 is a flowchart used for explaining processing carried out by the billing server 5.

The flowchart begins with a step S501 at which the request-determining unit 502 forms a judgment as to whether or not the received signal is settlement information used for settling a rental fee. If the outcome of the judgment indicates that the received signal is settlement information used for settling a rental fee, the flow of the processing goes on to a step S502 at which the settlement-processing unit 504 carries out settlement processing to pay the rental fee.

Then, at the next step S503, the settlement-process-determining unit 505 forms a judgment as to whether or not the fee settlement has been completed normally. If the out come of the judgment indicates that the fee settlement has been completed normally, the flow of the processing goes on to a step S504 at which the approval/disapproval-signal, detailed-statement and warning-information-generating unit 506 generates an approval signal and transmits the approval signal to the user terminal by way of the transmitting unit 507. Subsequently, at the next step S505, the approval/disapproval-signal, detailed-statement and warning-information-generating unit 506 generates detailed-statement information and transmits the information to the user terminal by way of the transmitting unit 507.

If the outcome of the judgment indicates that the fee settlement was not completed normally, on the other hand, the flow of the processing goes on to a step S506 at which the approval/disapproval-signal, detailed-statement and warning-information-generating unit 506 generates a disapproval signal and transmits the signal to the user terminal by way of the transmitting unit 507. Subsequently, at the next step S507, the approval/disapproval-signal, detailed-statement and warning-information-generating unit 506 transmits a warning to the user terminal by way of the transmitting unit 507.

Then, at the next step S508, the request-determining unit 502 forms a judgment as to whether or not the received signal is settlement information used for apportioning a deposit or for refunding a deposit. If the outcome of the judgment indicates that the received signal is settlement information used for apportioning a deposit or for refunding a deposit, the flow of the processing goes on to a step S509. To be more specific, if the outcome of the judgment indicates that the received signal is settlement information used for apportioning a deposit, the deposit-settlement-processing unit 503 apportions the deposited money. If the outcome of the judgment indicates that the received signal is settlement information used for refunding a deposit, on the other hand, the deposit-settlement-processing unit 503 returns the deposit money to the user 1.

The flow of the processing then goes on to a step S510 to form a judgment as to whether or not a termination command has been received. If a termination command has been received, the processing is ended. If a termination command has not been received, on the other hand, the flow of the processing goes back to the step S501.

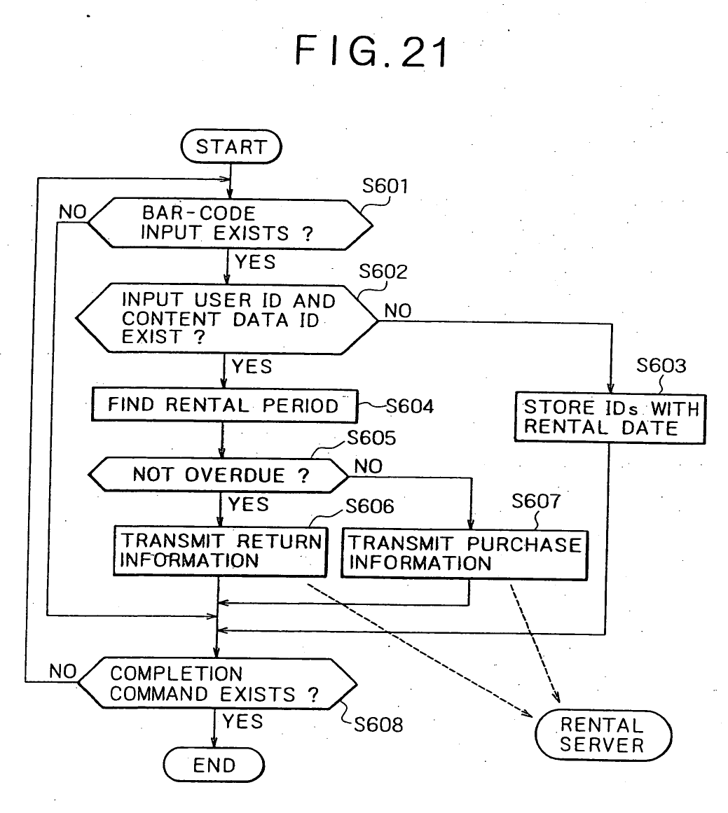

FIG. 21 is a flowchart used for explaining processing carried out by the post office 6.

The flowchart begins with a step S601 at which the bar-code input unit 601 inputs a bar code. Then, at the next step S602, the search unit 603 searches the storage unit 602 for data matching a user ID and a content ID which are included in the input bar code.

If the storage unit 602 does not include IDs matching respectively the user ID and the content ID which are included in the input bar code, the flow of the processing goes on to a step S603 at which the user ID and the input content ID are stored in the storage unit 602.

If the storage unit 602 includes IDs matching respectively the user ID and the content ID which are included in the input bar code, on the other hand, the flow of the processing goes on to a step S604 at which the rental-period-processing unit 604 finds a rental period.

Then, at the next step S605, the overdue-determining unit 605 forms a judgment as to whether or not a rented content is overdue on the basis of a processing result output by the rental-period-processing unit 604.

If the outcome of the judgment indicates that the rented content is not overdue, the flow of the processing goes on to a step S606 at which the return-information-generating unit 606 generates return information and transmits the information to the rental server 4 by way of the transmitting unit 608. If the outcome of the judgment indicates that the rented content is overdue, on the other hand, the flow of the processing goes on to a step S607 at which the purchase-information-generating unit 607 generates purchase-information and transmits the information to the rental server 4 by way of the transmitting unit 608.

The flow of the processing then goes on to a step S608 to form a judgment as to whether or not a termination command has been received. If a termination command has been received, the processing is ended. If a termination command has not been received, on the other hand, the flow of the processing goes back to the step S601.

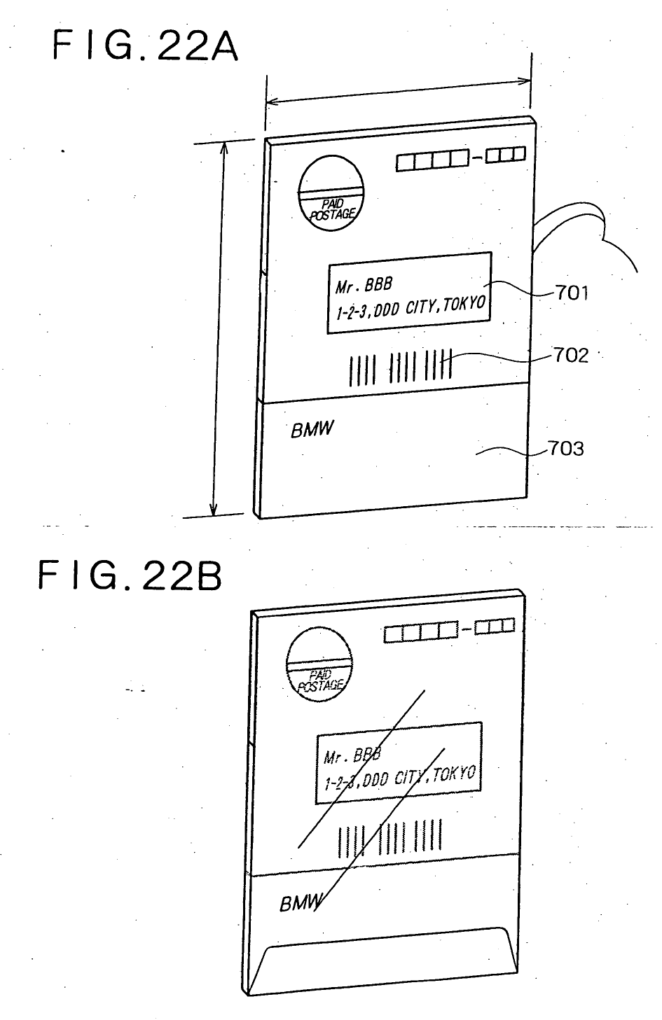

FIG. 22A is a diagram showing a typical package for packing a storage medium to be sent to the user 1. The package has typical dimensions such as a height of 23.5 cm and a width of 12 cm. The front surface of, the package displays an addressee 701, a bar code 702 and an advertisement 703 which is printed on the package typically for an enterprise. In this way, the rental company is capable of reducing the transportation cost by collecting a revenue for letting the enterprise place an advertisement. In addition, part of the advertisement revenue can also be donated to an environment protection agency or the like.

On the side surfaces of the package, perforation not shown in the figure is provided. Thus, the package can be opened by tearing the package along the perforation as shown in FIG. 22A.

FIG. 22B is a diagram showing a typical case in which the package of FIG. 22A with a sheet of transparent paper used to wrap the package. The sheet of transparent paper protects the storage medium and the package against moistures, dusts and the like.

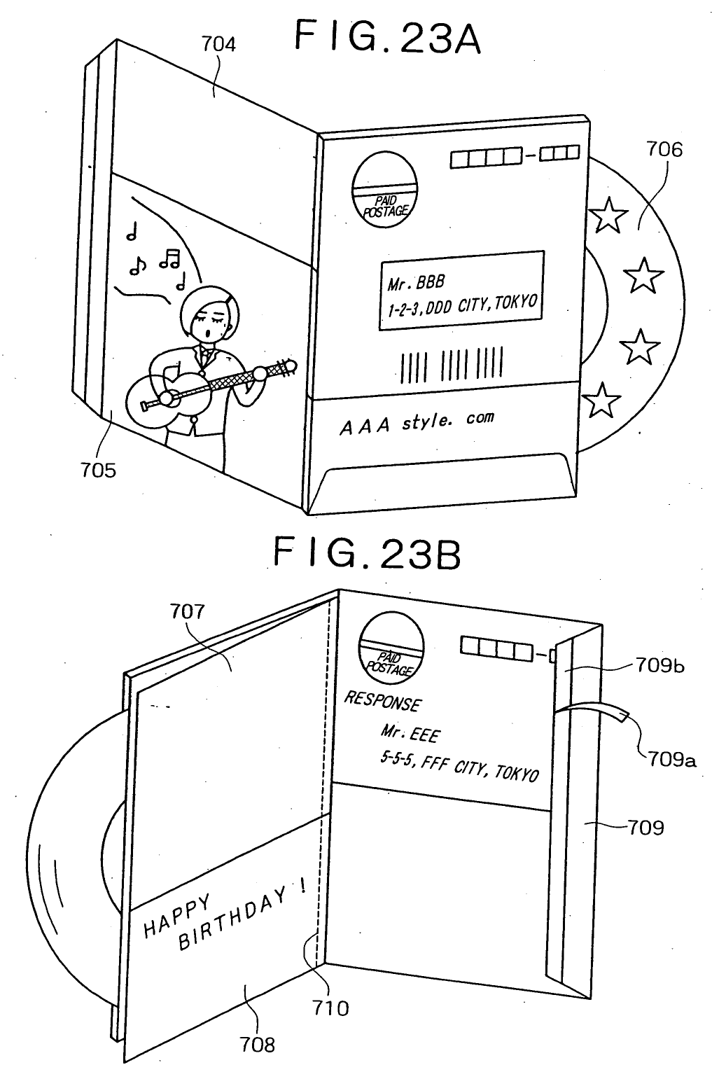

FIG. 23A is a diagram showing an opened package. The back surface of the package includes a questionnaire response portion 704 and a bromide 705. The user 1 may enter responses to a questionnaire set by the rental company to the questionnaire response portion 704 when the user 1 returns the storage medium. The bromide 705 is a picture of an artist desired by the user 1. In addition, a CD accommodated in the package has an original printed surface 706.

FIG. 23B is a diagram showing the inner configuration of an opened package. As shown in FIG. 23B, inside the package, there are a lyrics card 707 and a message card 708. At the inner edge of the lyrics card 707 and the message card 708, perforation 710 is provided so that the lyrics card 707 and the message card 708 can be detached from the package when the package is returned.

In addition, the package also includes a stick portion 709 which comprises a double-face tape 709b and a separator 709a on the double-face tape 709b. When the package is folded to make the rear surface of the package face the front surface thereof, the separator 709a can be peeled off from the double-face tape 709b to paste the rear surface on the front surface. In this way, the package used for a delivery of a storage medium can be used for returning the storage medium.

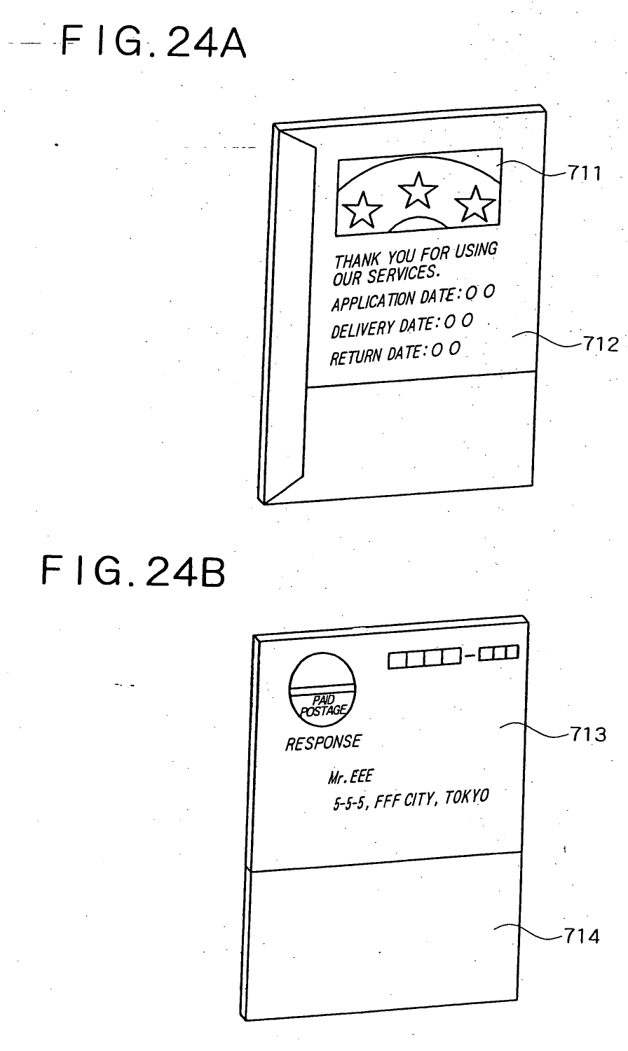

FIG. 24A is a diagram showing the rear surface of the package used for returning the storage medium. As shown in FIG. 24A, the rear surface includes a window portion 711 and a caution portion 712. The window portion 711 is typically a sheet of transparent and thin plastic so that the contents of the returned package can be verified through the window portion 711. The caution portion 712 shows information such as an application date, a delivery date and a return date.

FIG. 24B is a diagram showing the front surface of the package used for returning the storage medium. The front surface shows an addressee 713 to which the package is to be returned and an advertisement 714.

A typical basic charging system adopted in the rental system described above is explained as follows.

In the case of a CD album:

Rental basic fee: 600 yen

Breakdown:

Copyright fee: 180 yen (=3,000×6/100)

Transportation fee (delivery and return): 160 yen

Settlement handling fee: 9 yen (=600 yen×1.5%)

Corporate margin: 251 yen (including the storage medium's price of 100 yen)

Deposit: 1,400 yen

In the case of a CD single:

Rental basic fee: 400 yen

Breakdown:

Copyright fee: 60 yen (=1,000×6/100)

Transportation fee (delivery and return): 100 yen

Settlement handling fee: 3 yen (=400 yen×1.5%)

Corporate margin: 237 yen (including the storage medium's price of 100 yen)

Deposit: 500 yen

In the case of typically 10 best hits:

Rental basic fee: 1,000 yen

Breakdown:

Copyright fee charged by singles: 60 yen×10 (=1,000×6/100)

Transportation fee (delivery and return): 160 yen

Settlement handling fee: 17 yen (=1,100 yen×1.5%)

Corporate margin: 323 yen (including the storage medium's price of 100 yen)

Deposit: 1,500 yen

Optional fees:

Electronic music box: 300 yen

CD level printing: 300 yen

Message: 200 yen

Bromide: 200 yen

Special delivery: 360 yen

Special date (Sunday): 200 yen

Registered parcel: 440 yen

In the case of purchasing a rented content at a basic price:

Album: 600 yen+1,400 yen=2,000 yen

Single: 400 yen+500 yen=900 yen

Mix of 10 pieces of music: 1,000 yen+1,500 yen=2,500 yen

As described above, the basic rental fee of a rented content is lower than the conventional purchasing price of the medium. It should be noted that the basic rental fee of an MD (Mini Disc) used as a rented content is the same as the basic fee of a CD.

In addition, in the case of purchasing a rented content, 1.5% of the deposit money is paid to the fee-settlement company and the rest is apportioned between the rental company and the record-producing company. The money apportioned to the record-producing company is further apportioned to artists, production of records and other related parties. It should be noted that, if combined with the rental fee, the revenue of the copyright owner is greater than a profit gained from the conventional CD sales.

In the case of a DVD:

Rental basic fee: 1,000 yen

Breakdown:

Copyright fee charged by singles: 210 yen×10 (=3,500×6/100)

Transportation fee (delivery and return): 160 yen

Settlement handling fee: 15 yen (=1,000 yen×1.5%)

Corporate margin: 615 yen (including the storage medium's price of 200 yen, the frequency of use: 10)

Deposit: 2,000 yen

Embodiments of the present invention have been explained in concrete terms so far. However, the scope of the present invention is not limited to the embodiments described above. That is to say, it is possible to make a variety of changes based on technological concepts introduced by the present invention.

In the case of the embodiments explained above, for example, the rental company carries out processing such as recording of a content onto a storage medium and printing of an addressee on a package. It should be noted, however, that it is also possible to provide a rental system with a configuration wherein the post office carries out this processing.

In addition, in the case of the embodiments explained above, the user 1 has to automatically purchase a storage medium that is overdue beyond a rental period. It is worth noting, however, that an overdue storage medium can also be made inaudible.

Furthermore, in the case of the embodiments explained above, the least costly postal mail system is used as a transportation means. It should be noted, however, that it is also possible to provide another cheap system as a transportation means. An example of the cheap system is a package delivery system.

Moreover, the embodiments explained above each have a configuration wherein a piece of music is rented as a rented content. It is worth noting, however, that the rental system can also have a configuration wherein a rented content is picture data such as a movie or a static picture, a program such as game software or a control program, a broadcasted content such as a TV or radio program or another kind of content.

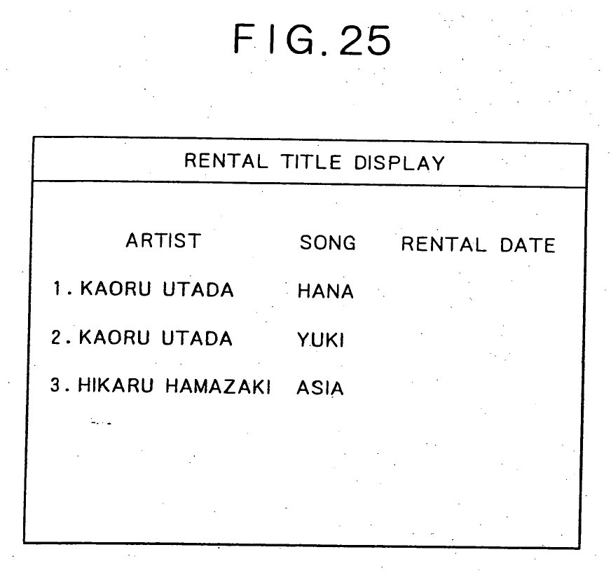

In addition, the embodiments explained above each have a configuration wherein a screen for setting rental conditions is displayed. It should be noted, however, that the rental system can also have a configuration wherein a screen for allowing the user 1 to verify titles of rented songs is displayed as shown in FIG. 25.

Furthermore, the embodiments explained above each have a configuration wherein a post office serves as a window for handling returned storage mediums. It is worth noting, however, that the rental system can also have a configuration wherein a convenience store or the like serves as such a return window.

Moreover, in the case of the embodiments explained above, a user terminal is used for placing an order for a storage medium to be rented. It should be noted, however, that the user 1 can also use a terminal installed at a kiosk, a rental store, a convenience store, a CD shop store, a bookstore or the like to place an order for a storage medium to be rented.

In addition, in the case of the embodiments explained above, a rental date is stored in a storage unit employed in a rental server. It is worth noting, however, that a rental date can also be stored in a bar code printed on a package or a rented storage medium.

Furthermore, the rental company can also accumulate points for a user in dependence on the number of times the user 1 utilizes the service rendered by the rental company. Moreover, accumulated points can be linked to points accumulated by another company.

If rental servers are scattered at sites all over the country, even a user living in an isolated island with poor transportation facilities can rent a storage medium by mail. Such a user can receive a rented content on a day following a day an order for the storage medium is placed. As a result, storage mediums can be rented to users living at far locations all over the country at a low cost.

In addition, in the case of the embodiments explained above, after a rented content is returned, money is refunded to a bank account of the user 1. The amount of the refunded money is equal to a difference obtained as a result of subtraction of a handling fee charged by the fee-settlement company from an amount of money deposited in advance. It should be noted, however, that the money to be refunded can instead be transformed into points and put in a pool so that the money can be spent in the next renting, for shopping or for other purposes.

The series of pieces of processing described above can be carried out by hardware or through execution of software. When execution of software is selected for carrying out the series of pieces of processing, a variety of programs composing the software are installed in a recording memory employed in typically a general-purpose computer.

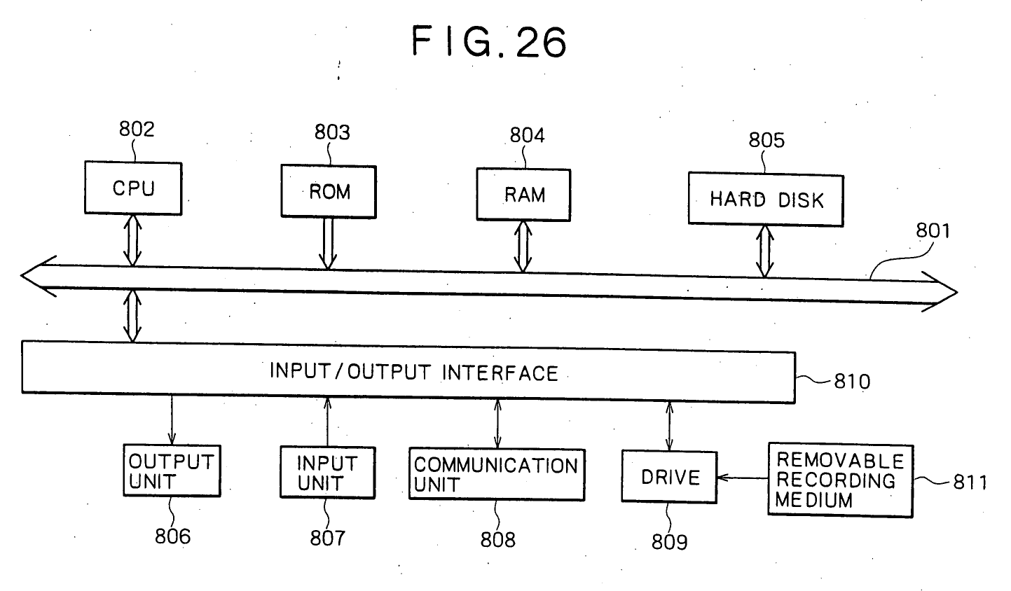

FIG. 26 is a diagram showing a typical configuration of an embodiment implementing a computer for carrying out the series of pieces of processing by execution of programs installed in the computer.

To put it concretely, the programs can be stored in a recording medium employed in the computer. Examples of the recording medium are a hard disk 805 and a ROM (Read-Only Memory) 803.

The programs can also be stored permanently or temporarily in a removable recording medium 811 such as a floppy disk, a CD-ROM (Compact-Disk Read-Only Memory), an MO (Magneto Optical) disk, a DVD (Digital Versatile Disk), a magnetic disk or a semiconductor memory. The programs stored in such a removable recording medium 811 are presented to the user as the so-called package software.

The programs presented as package software are then installed in the computer from the removable recording medium 811. It should be noted that, as an alternative to the removable recording medium 811, the programs can also be downloaded from a download site to the computer by radio communication by way of an artificial satellite for digital satellite broadcasting. As another alternative, the programs can also be downloaded from the download site to the computer by wire communication by way of a network such as a LAN (Local Area Network) or the Internet. In the computer, the downloaded programs are received by a communication unit 808 to be installed in the hard disk 805 embedded in the computer.

The computer includes an embedded CPU (Central Processing Unit) 802. The CPU 802 is connected to an input/output interface unit 810 by a bus 801. The CPU 802 receives commands from an input unit 807 by way of the input/output interface unit 810. The commands are entered by the user via the input unit 807. The input unit 807 includes a keyboard, a mouse and a microphone. The CPU 802 executes a program stored in advance in the. ROM 803 or installed in advance in the hard disk 805. The program executed by the CPU 802 is selected in accordance with a received command. As an alternative, the program is newly installed in the hard disk 805 in accordance with a received command when the command is received by the CPU 802. The newly installed program is downloaded through a satellite or a network and received by the communication unit 808. As another alternative, the newly installed program is read out from the removable recording medium 811 mounted on a drive unit 809. The program to be executed by the CPU 802 is loaded from the ROM 803 or the hard disk 805 into a RAM (Random-Access Memory) 804. By execution of such a program, the CPU 802 carries out processing represented by the flowchart shown in any one of FIGS. 16, 17, 18, 19, 20 and 21 or another figure, or processing in the configuration shown in any block diagram of FIGS. 6, 11, 12, 13, 14 and 15 or another configuration. Then, if necessary, the CPU 802 typically outputs a result of the processing to an output unit 806 by way of the input/output interface unit 810. The output unit 806 includes an LCD (Liquid Crystal Display) and a speaker. As a typical alternative, the CPU 802 may also transmit the result of processing through the communication unit 808 or stores the result in the hard disk 805.

It should be noted that, in this specification, while steps prescribed in a program recorded in a recording medium can of course be executed sequentially along the time axis in an order the steps are prescribed in the program, the steps are not always executed sequentially along the time axis. That is to say, a program may include steps that are executed concurrently or individually in typically parallel processing or object-oriented processing.

In addition, a program can be executed by one computer or a plurality of computers in distributed processing. Furthermore, a program may be transmitted to a remote computer to be executed thereby.

1-11. (canceled)

12. A communication system comprising a first communication apparatus and a second communication apparatus, wherein:
said first communication apparatus has:
rental-request-information-generating means for generating rental-request information including a musical-data ID and a storage-medium ID of respectively musical data and a storage medium which are desired by the user; and
transmitting means for transmitting said rental-request information generated by said rental-request-information-generating means, and
said second communication apparatus has:
receiving means for receiving said rental-request information transmitted by said transmitting means;
search means for searching for musical data identified by said musical-data ID included in said rental-request information received by said receiving means;
write means for writing said musical data searched for by said search means and said musical-data ID into a storage medium identified by said storage-medium ID; and
recording means for recording a rental date of transmission of a rented storage medium to a delivery destination and a return date of returning said rented storage medium from said delivery destination.

13. A communication system according to claim 12 wherein said second communication apparatus further has printing means for printing said delivery destination address based on said rental-request information on a package for accommodating said storage medium.

14. A communication system according to claim 13 wherein:
said package is a return envelop comprising:
a first surface including a first blank area for recording said address of said delivery destination;
an accommodation portion for accommodating said storage medium; and
a second surface including a second blank area for recording an address of a return destination, and
said printing means prints said address of said delivery destination in said first blank area on said first surface and said address of said return destination in said second blank area on said second surface.

15. A communication system according to claim 12 wherein said second communication apparatus further has fee-settlement means for generating fee-settlement information used for drawing a rental fee according to said rental-request information from an account of said user and for transmitting said fee-settlement information to an external fee-settlement center.

16. A communication system according to claim 15 wherein said fee-settlement means stores a deposit for renting of said storage medium in accordance with said rental-request information.

17. A communication system according to claim 16 wherein:
there is further provided comparison means for comparing an actual return date of actually returning said storage medium from said delivery destination with said rental date and/or said return date which were recorded by said recording means; and
said fee-settlement means generates fee-settlement information used for refunding said deposit to said user and transmits said fee-settlement information to said external fee-settlement center if said comparison means determines that said storage medium is returned within a rental period.

18. A communication system according to claim 17 wherein said fee-settlement means generates fee-settlement information used for apportioning said deposit to a rental-service provider and transmits said fee-settlement information to said external fee-settlement center if said comparison means determines that said storage medium is not returned within a rental period.

19. A communication system according to claim 12 wherein said recording means records said rental date and said return date on said rented storage medium.

20. A communication system according to claim 13 wherein said printing means prints said rental date and said return date on a portion of said package in the form of a bar code.

21. A communication apparatus comprising:
receiving means for receiving rental-request information transmitted by an external apparatus;
search means for searching for content data identified by a content-data ID included in said rental-request information received by said receiving means;
write means for writing said content data searched for by said search means and said content-data ID into a storage medium identified by a storage-medium ID included in said rental-request information; and
recording means for recording a rental date of transmission of a rented storage medium to a delivery destination and a return date of returning said rented storage medium from said delivery destination.

22. A communication apparatus according to claim 21 further comprising printing means for printing said delivery destination address based on said rental-request information on a package for accommodating said storage medium.

23. A communication apparatus according to claim 22 wherein:
said package is a return envelop comprising:
a first surface including a first blank area for recording said address of said delivery destination;
an accommodation portion for accommodating said storage medium; and
a second surface including a second blank area for recording an address of a return destination, and
said printing means prints said address of said delivery destination in said first blank area on said first surface and said address of said return destination in said second blank area on said second surface.

24. A communication apparatus according to claim 21 further comprising fee-settlement means for generating fee-settlement information used for drawing a rental fee according to said rental-request information from an account of said user and for transmitting said fee-settlement information to an external fee-settlement center.

25. A communication apparatus according to claim 24 wherein said fee-settlement means stores a deposit for renting of said storage medium in accordance with said rental-request information.

26. A communication apparatus according to claim 25 further comprising comparison means for comparing an actual return date of actually returning said storage medium from said delivery destination with said rental date and/or said return date which were recorded by said recording means and wherein
said fee-settlement means generates fee-settlement information used for refunding said deposit to said user and transmits said fee-settlement information to said external fee-settlement center if said comparison means determines that said storage medium is returned within a rental period.

27. A communication apparatus according to claim 26 wherein said fee-settlement means generates fee-settlement information used for apportioning said deposit to a rental-service provider and transmits said fee-settlement information to said external fee-settlement center if said comparison means determines that said storage medium is not returned within a rental period.

28. A communication apparatus according to claim 21 wherein said recording means records said rental date and said return date on said rented storage medium.

29. A communication apparatus according to claim 22 wherein said printing means prints said rental date and said return date on a portion of said package in the form of a bar code.

30-31. (canceled)

32. A communication method comprising the steps of:
generating rental-request information including a musical-data ID and a storage-medium ID of respectively musical data and a storage medium which are desired by the user,
transmitting said generated rental-request information;
receiving said transmitted rental-request information;
searching for musical data identified by said musical-data ID included in said received rental-request information;
writing said searched musical data and said musical-data ID into a storage medium identified by said storage-medium ID included in said received rental-request information; and
recording a rental date of transmission of said storage medium to be rented to a delivery destination and a return date of returning said rented storage medium from said delivery destination.

33. A communication method comprising the steps of:
receiving rental-request information transmitted by an external apparatus;
searching for content data identified by a content-data ID included in said received rental-request information;
writing said searched content data and said content-data ID into a storage medium identified by a storage-medium ID included in said received rental-request information; and
recording a rental date of transmission of a rented storage medium to a delivery destination and a return date of returning said rented storage medium from said delivery destination.

34-35. (canceled)

36. A recording medium for storing a program comprising the steps of:
generating rental-request information including a musical-data ID and a storage-medium ID of respectively musical data and a storage medium which are desired by the user;
transmitting said generated rental-request information;
receiving said transmitted rental-request information;
searching for musical data identified by said musical-data ID included in said received rental-request information;
writing said searched musical data and said musical-data ID into a storage medium identified by said storage-medium ID included in said received rental-request information; and
recording a rental date of transmission of said storage medium to be rented to a delivery destination and a return date of returning said rented storage medium from said delivery destination.

37. A recording medium for storing a program comprising the steps of:
receiving rental-request information transmitted by an external apparatus;
searching for content data identified by a content-data ID included in said received rental-request information;
writing said searched content data and said content-data ID into a storage medium identified by a storage-medium ID included in said received rental-request information; and
recording a rental date of transmission of a rented storage medium to a delivery destination and a return date of returning said rented storage medium from said delivery destination.

38. (canceled)
